(19) United States
(12) Patent Application Publication
(10) Pub. No.: US 2024/0394703 A1
(43) Pub. Date: Nov. 28, 2024

(54) PAYMENT PREPARATION ORCHESTRATION FOR A PAYMENT MANAGEMENT SYSTEM

(71) Applicant: Amadeus S.A.S., Biot (FR)

(72) Inventors: Antonin GUEROULT, Biot (FR); Mathieu LE MARIER, Geneva (CH); Clement OLIVA, Valbonne (FR); Damien ROMAND, Opio (FR); Marzia MARMORE, Antibes (FR)

(21) Appl. No.: 18/373,087

(22) Filed: Sep. 26, 2023

(30) Foreign Application Priority Data
May 22, 2023 (EP) 23305806.4

(51) Int. Cl. G06Q 20/40; G06Q 20/36; G06Q 20/38

(52) U.S. Cl. CPC G06Q 20/401; G06Q 20/36; G06Q 20/389

(57) ABSTRACT

Methods, systems, and computer program products for implementing a payment preparation orchestration process for travel management systems. A payment request including a travel record identification is received at a payment preparation orchestration server via a payment preparation user interface. A payment identification is associated with the travel record identification, and the payment preparation user interface provides access to a plurality of payment processor servers. The payment preparation orchestration server obtains eligible payment processor information associated with the travel record identification from a reservation system. The payment preparation orchestration server accesses a first software development kit (SDK) from a first payment provider and a second SDK from a second payment provider based on the eligible payment processor information. The payment preparation orchestration server then updates the payment preparation user interface with a first interface element associated with the first SDK and a second interface element associated with the second SDK.

### TECHNICAL FIELD

The present invention generally relates to computers and computer software, and more specifically, to methods, systems, and computer program products for implementing a payment preparation orchestration process.

### BACKGROUND

In order for a travel provider to be able to handle moving towards a more standard retail industry approach for integrating multiple payment transactions from different software systems, a travel provider needs to ensure that their frontend systems and customer graphical user interface (GUI) touchpoints maintain synergies between the sales channels (e.g., the New Distribution Capability (NDC) context such as passenger name record (PNR) systems, online centers, call centers, operations, etc.) and the payment context. Merchants need to integrate the various software systems and services individually on their touchpoints in order to accept payments. For example, the airline industry may desire to offer payment scope (e.g., credit cards, digital payment vehicles, cryptocurrency, fraud check, and the like) on all the airline merchants digital touchpoints (e.g., booking, check-in, etc.). Airlines will need to integrate each of the different software systems on their website which can lead to an increase in cost for an airline, longer time to market, increase in complexity in the systems/processes, etc. Additionally, a payment operation related to payment and the PNR needs to be performed via on the backend servers (e.g., reward payments such as using miles with cash payments, fee calculations, etc.). Moreover, the airline industry will also need to maintain their PNR integration and payment orchestration logic on backend side to match with the payment software systems integrated on their frontends.

In some conventional reservation systems, payment information is provided in a manner such that the payment information cannot be authenticated. For example, a travel customer may communicate with a travel agent using telephone communication, and the travel customer may provide the travel agent payment information verbally. In this example, the travel agent enters the payment information at a reservation device, such as a computer, and the payment information is not verified/authenticated. As another example, if a travel customer books travel with a travel agent in person, unless the travel agency is equipped with electronic payment capture devices (i.e., credit card readers, etc.), the payment information (e.g., a credit card number) may still be fraudulent. As such, for these conventional payment channels for travel reservations, the payments submitted through such channels may be considered unsecure.

In general, unsecured payments increase costs for travel merchants (e.g., airlines, rail travel providers, hotels, etc.), travel booking systems (e.g., global distribution systems), and/or third party reservation services (e.g., travel agencies), as liability for fraudulent payments through unsecured payment channels typically remains with the travel merchant, travel booking system, and/or third party reservation service. In addition, because the travel merchant, booking system, and/or third-party reservation service handle the payment information for such unsecured payment channels, the travel merchant, booking system, and/or third-party reservation service may be required to comply with various security standards for sensitive payment information. For example, the travel merchant, booking system, and/or third-party reservation service may be required to comply with the Payment Card Industry Data Security Standard (PCI DSS), which is an information security standard for organizations that handle cardholder information for many debit, credit, prepaid, e-purse, ATM, and point of sale (POS) payment cards. Complying with such standards typically increases costs associated with processing payments for travel reservations.

Moreover, many travel merchants and reservation systems utilize a travel agency selling model, i.e., travel agencies distribute a travel merchant's products on behalf of the travel merchant. However, the travel merchant generally is liable for the payment, even in the case of fraudulent payments. Therefore, in conventional systems utilizing the travel agency selling model, travel merchants are generally dependent on travel agency procedures to secure payments.

Whenever travel merchants and reservation systems accept payment, they need to be sure that the data is consistent and that they are able to provide all necessary information (e.g., the code, etc.) that they might require for the eventual accounting reconciliation purpose. For example, the travel merchants need to ensure that data is available for their back office and have the capability to maintain an integration of payment data inside their booking system. Thus, improved methods, systems, and computer program products for providing improved payment preparation orchestration systems for travel bookings are needed.

### SUMMARY

In embodiments of the invention, a method for implementing a payment preparation orchestration process. The method, at a device including one or more processors, receiving a payment request via a payment orchestration user interface at a client device, wherein the payment request is encoded with payment identification information, and the payment orchestration user interface provides access to a plurality of payment processor servers and a plurality of payment service modules. The method further includes obtaining configuration data associated with a merchant corresponding to the payment request. The method further includes determining payment transaction data based on the payment identification information and the configuration data associated with the merchant. The method further includes determining a subset of the plurality of payment service modules to engage based on the payment transaction data. The method further includes determining payment preparation data by managing access to each payment service module of the subset of the plurality of payment service modules. The method further includes providing, via the payment orchestration user interface at the client device, a view of the payment preparation data.

These and other embodiments can each optionally include one or more of the following features.

In some embodiments of the invention, the configuration data associated with the merchant corresponding to the payment request includes payment rules. In some embodiments of the invention, the payment preparation data includes at least one or more of payment orchestration data, payment instruments, traveler related data, and payment options.

In some embodiments of the invention, the plurality of payment service modules includes at least one or more of a form of payment (FOP) catalogue module, an installment module, a currency conversion module, a payment wallet module, a FOP solution module, a balance inquiry module, a reward integration module, a user interface module, and an authentication module.

In some embodiments of the invention, the FOP solution module is configured to offer a dispatch of payment instruments for various products associated with the payment request based on products to buy, the payment instruments selected by the traveler, and applicability constraints.

In some embodiments of the invention, prior to providing the view of the payment preparation data, performing a validation process to verify each of the accessed payment service modules of the plurality of payment service modules were correctly selected.

In some embodiments of the invention, the payment request is associated with a travel booking request. In some embodiments of the invention, the payment request is received from a travel provider server via a booking engine.

In some embodiments of the invention, a device including a non-transitory computer-readable storage medium, and one or more processors coupled to the non-transitory computer-readable storage medium, wherein the non-transitory computer-readable storage medium includes program instructions that, when executed by the one or more processors, cause the one or more processors to perform the method as described above.

In some embodiments of the invention, a computing apparatus including one or more processors, at least one memory device coupled with the one or more processors, and a data communications interface operably associated with the one or more processors, where the memory device contains a plurality of program instructions that, when executed by the one or more processors, cause the computing apparatus to perform the method as described above.

In some embodiments of the invention, a non-transitory computer storage medium encoded with a computer program is provided, where the computer program includes a plurality of program instructions that when executed by one or more processors cause the one or more processors to perform the method as described above.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates an example environment for implementing a payment preparation orchestration process, according to embodiments of the invention.

FIG. 2 illustrates an example payment preparation orchestration process based on a payment request, according to embodiments of the invention.

FIGS. 3A-3C illustrate example routines in the form of a sequence diagram that may be performed by the example environment shown in FIG. 1 as a procedure to facilitate a payment preparation orchestration process for a travel booking, according to embodiments of the invention.

FIGS. 4A-4C illustrate example routines in the form of a sequence diagram that may be performed by the example environment shown in FIG. 1 as a procedure to facilitate a payment preparation orchestration process for a travel booking, according to embodiments of the invention.

FIG. 5 is a flowchart of an example process for implementing a payment preparation orchestration process, according to embodiments of the invention.

FIGS. 6A-6F illustrate example routines in the form of a sequence diagram that may be performed by the example environment shown in FIG. 1 as a procedure to facilitate a form of payment orchestration process for a travel booking, according to embodiments of the invention.

FIG. 7 is a flowchart of an example process for implementing a form of payment orchestration process, according to embodiments of the invention.

FIG. 8 is a block diagram showing an example computer architecture for a computer capable of executing the software components described herein, according to embodiments described herein.

### DETAILED DESCRIPTION

The technology in this patent application is related to systems and methods for implementing a payment preparation orchestration process (e.g., a prepare payment service) utilizing one or more payment orchestration servers that are in communication with the travel providers, travel reservation systems, and payment processors via a payment platform gateway. The payment preparation orchestration process integrates a plurality of front-end services to prepare a system for payment, and thus require a complex orchestration aspect on front-end side to be able to call the services in the right order and at the right time of the payment flow. The prepare payment service seeks to solve this orchestration problem for the front-end, centralizing the orchestration logic, and overcome a significant technical obstacle on how to identify properly the different use cases on the payment side to trigger a correct orchestration sequence. The invention utilizes a REST API that would be provided to a front-end payment process service that may allow the payment process to benefit from connectivity with a plurality of payment related services with an easy integration, to offer the best experience to a traveler in terms of payment preparation steps (e.g., retrieve the forms of payments to pay with and their associated options-installments, payment in other currencies, using loyalty points, etc.).

In an exemplary embodiment, an API query is encoded by a booking engine associated with a merchant (e.g., an airline) and sent to and decoded by a payment orchestration server (e.g., REST API encoding/decoding). The payment orchestration server, based on the decoded input and on an internal configuration of the merchant associated with the booking engine, a series of services will be called in order to perform processes and gather data. The orchestration data may then be encoded in the API response which is sent to the front-end to display all needed information for the traveler to choose what he or she wants to pay with, and with which payment options.

In some embodiments of the invention, the different series of services include one more payment preparation orchestration modules. The payment preparation orchestration modules may include a form of payment (FOP) catalogue module provides the list of eligible payment methods given the payment context (e.g., type of merchant, products, country, etc.). The payment preparation orchestration modules may include an installment module that is configured to manage payments in several iterations. The payment preparation orchestration modules may include a currency conversion module that is configured to manage payments in a different currency than the one initially proposed by the merchant. The payment preparation orchestration modules may include a payment wallet module that is configured to retrieve the payment instruments stored in a payment wallet, such as user profile information (e.g., travel data), payment methods, vouchers, etc. The payment preparation orchestration modules may include an FOP solution module that is configured to offer a dispatch of the payment instruments on the various products based on, for example, the products to buy, the payment instruments selected by the traveler, and the applicability constraints of both (e.g., different rules for dispatching, such as voucher first, miles, etc., before cash/credit). The payment preparation orchestration modules may include a balance inquiry module that is configured to retrieve a loyalty account of a traveler (e.g., miles balance, tier list, and other loyalty account information). The payment preparation orchestration modules may include a user interface module for generating and managing a payment preparation orchestration user interface (e.g., a front-end API such as a “payment page”) at a client device (e.g., from a travel provider server via a booking engine). The payment preparation orchestration modules may include a reward integration module that is configured to compute various ranks needed to display and manage various functions and user interface elements in the payment preparation orchestration user interface, such as a reward slider for the user to select to pay partially in miles and partially in cash. The payment preparation orchestration modules may include an authentication module to verify a user making the payment on a client device via a merchant webpage from a reservation server.

More specifically, this technology includes a process that receives a payment request via a payment orchestration user interface (e.g., a front-end API—“payment page”) at a client device (e.g., from a travel provider server via a booking engine). The payment request is encoded with payment identification information, and the payment orchestration user interface provides access to a plurality of payment processor servers and a plurality of payment service modules. The process further obtains configuration data associated with a merchant corresponding to the payment request (e.g., internal configuration of the merchant, such as payment rules, i.e., vouchers before loyalty points/miles), and determined payment transaction data based on the payment identification information and the configuration data associated with the merchant (e.g., decode the request). The process further determines a subset of the plurality of payment service modules to engage based on the payment transaction data (e.g., determine which of the micro-services to access for the particular request). The process further determines payment preparation data (e.g., payment orchestration data, payment instruments, traveler related data (i.e., specific card numbers, online payment accounts, and the like) or payment options (e.g., installments, currency conversion)) by managing access to each payment service module of the subset of the plurality of payment service modules. The process further provides, via the payment orchestration user interface at the client device, the payment preparation data (e.g., display results on the payment page).

Although the examples provided herein reference the travel industry, the payment preparation orchestration processes described may be applied to any order management system.

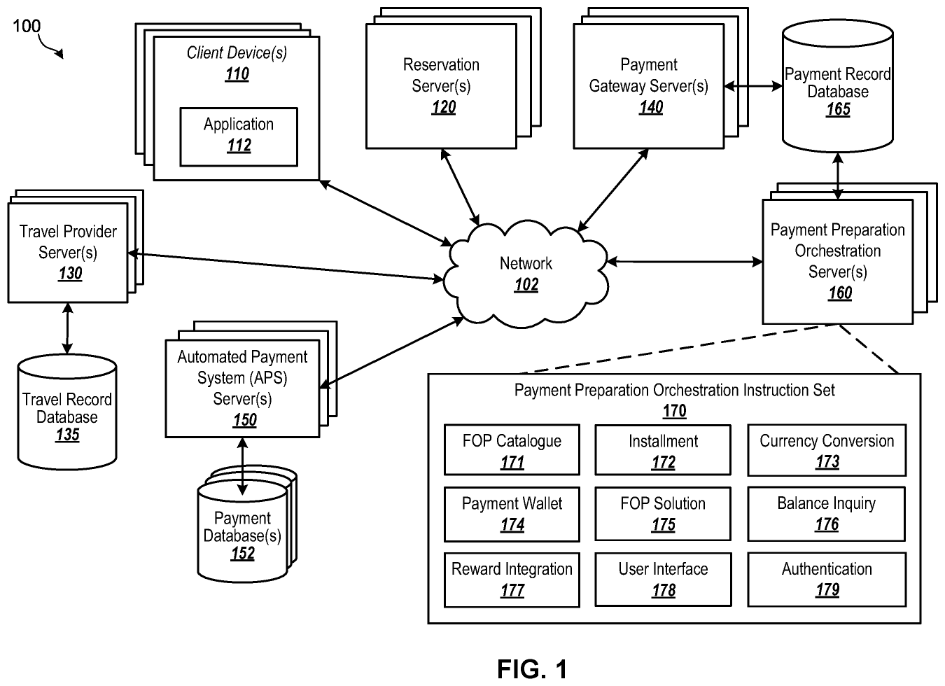

FIG. 1 is an example operating environment 100 of a distributed database environment for implementing a payment preparation orchestration process, according to embodiments of the invention. The example operating environment 100 includes one or more client device(s) 110, one or more travel reservation server(s) 120, one or more travel provider server(s) 130, one or more payment gateway server(s) 140, one or more payment processor server(s) 150, and one or more payment preparation orchestration server(s) 160, that communicate over a data communication network 102, e.g., a local area network (LAN), a wide area network (WAN), the Internet, a mobile network, or a combination thereof.

The one or more client device(s) 110 (e.g., a device used by a requestor) can include a desktop, a laptop, a server, or a mobile device, such as a smartphone, tablet computer, wearable device (e.g., smartwatch), in-car computing device, and/or other types of mobile devices. Additionally, the one or more client device(s) 110 may be public uses devices such as a kiosk, a user terminal, and the like. The one or more client device(s) 110 includes applications, such as the application 112, for managing a travel booking request to/from the one or more travel reservation server(s) 120. The one or more client device(s) 110 can include other applications. The one or more client device(s) 110 initiates a travel booking request by a requestor via application 112. The travel booking request may include availability search queries by requesting entities (such as clients, applications, browsers installed on user terminals, etc.) in the course of a search (e.g., airline booking search). The one or more client device(s) 110 may be utilized by a customer to review a reserved travel booking and provide and authenticate payment information for the reserved travel booking. Additionally, a requestor of a travel booking using the one or more client device(s) 110 may include an airline agency, travel agency, other dedicated global distribution systems (GDS), as for example airlines reservation systems which provide flight search applications for shopping business like flight booking, and the like.

The one or more travel reservation server(s) 120 manages travel booking requests received from application 112 from the one or more client devices 110. The one or more travel reservation server(s) 120 may be a personal computing device, tablet computer, thin client terminal, smart phone and/or other such computing device. The one or more travel reservation server(s) 120 receive booking data from a client device to reserve a travel reservation and generate a PNR for that particular travel product(s) associated with the booking data. Although a PNR is described as being generated, which is in regard to an example of an airline booking, the systems described herein could further include any other type of order management system for other travel providers, such as hotels, rental cars, etc., capable of generating a record associated with booking data. As such, in general, a reservation application executes on a reservation device (e.g., application 112 on client device 110) to generate a front-end through which a travel agent may interface with the reservation server 120 to reserve a travel booking for a travel customer. For example, a reservation device executing a reservation application may operate as a remote terminal connected to reservation server 120, and a travel agent may reserve a travel booking for a travel customer by interfacing with the reservation server 120 using the client device 110. For example, the client device 110 executing the reservation application may provide a command-line interface to a GDS embodied by the reservation server 120. In this example, the booking data communicated by the client device 110 may be in a travel agency format, such as command-line. Additionally, after a consumer on a client device 110 confirms an issuance for the particular travel product(s) associated with the booking data, a reservation server 120 initiates a payment process by sending an order request to the one or more travel provider server(s) 130 associated with the requested travel product(s) from the consumer.

The one or more travel provider server(s) 130 (e.g., travel merchants) generally include airlines, rail travel providers, hotels, and/or other such merchants that offer travel or travel-related services to customers using client devices 110. The one or more travel provider server(s) 130 generally facilitate remote communication therewith to reserve travel or travel-related service from a particular travel merchant. After a consumer on a client device 110 confirms an issuance for the particular travel product(s) associated with the booking data, a travel provider server 130 receives an order request from a reservation server 120 and initiates a payment process by requesting payment from the client device 110. After receiving a payment confirmation for a particular travel booking, a travel provider server 130 may request and receive a travel record ID from the reservation server 120 and send booking confirmation to the client device 110 via the reservation server 120. Additionally, the one or more travel provider server(s) 130 are configured to initiate a payment preparation orchestration process after receiving a payment confirmation from the one or more payment processor server(s) 150 via the one or more payment gateway server(s) 140 and sending booking confirmation data by sending a payment request to the one or more payment preparation orchestration server(s) 160.

The one or more travel provider server(s) 130 may be front-end server(s) for managing, collecting, processing, and communicating travel records (e.g., travel booking requests, resource information, revenues management data, bookings data, airlines/system configurations data, etc.), that is stored in the travel record database 135. Further, the one or more travel provider server(s) 130 may be front-end server(s) for managing, collecting, processing, and communicating payment requests and payment preparation orchestration data from one or more payment preparation orchestration server(s) 160 to the one or more reservation server(s) 120.

The one or more payment gateway server(s) 140 manages the payment transactions of travel booking requests received from application 112 between the one or more client devices 110 and the payment processor server(s) 150. The management protocols of the one or more payment gateway server(s) 140 may be based on a redundant load-balancing system by managing multiple clients (e.g., client device(s) 110) so that a payment associated with a travel booking request is handled by one of the one or more payment processor server(s) 150. For example, there may be multiple payment processor server(s) 150 that are able to service the travel booking payment, and the redundant load-balancing system of the payment gateway server(s) 140 is responsible for ensuring that the travel booking request is performed by one of the capable payment processor server(s) 150. Payment processors include for example, a credit/debit card issuer, a bank, digital payment service, etc., and the one or more servers for each payment processor generally facilitate remote communication therewith to authenticate and/or authorize a payment via a payment gateway server 140. The payment transaction data may be stored in one or more payment database(s) 152 associated with each payment processor.

The one or more payment preparation orchestration server(s) 160 receives and processes the payment request(s) from a reservation server 120. The one or more payment preparation orchestration server(s) 160 includes a payment preparation orchestration instruction set 170 that performs a payment preparation protocol according to processes described herein. The payment preparation orchestration instruction set 170 may include a plurality of service modules (also referred to herein as “payment preparation orchestration submodules” or “micro-services”).

The payment preparation orchestration instruction set 170 may include a form of payment (FOP) catalogue module 171 that provides the list of eligible payment methods given the payment context (e.g., type of merchant, products, country, etc.). The payment preparation orchestration instruction set 170 may include an installment module 172 that is configured to manage payments in several iterations. The payment preparation orchestration instruction set 170 may include a currency conversion module 173 that is configured to manage payments in a different currency than the one initially proposed by the merchant. The payment preparation orchestration instruction set 170 may include a payment wallet module 174 that is configured to retrieve the payment instruments stored in a payment wallet, such as user profile information (e.g., travel data), payment methods, vouchers, etc. The payment preparation orchestration instruction set 170 may include an FOP solution module 175 that is configured to offer a dispatch of the payment instruments on the various products based on, for example, the products to buy, the payment instruments selected by the traveler, and the applicability constraints of both (e.g., different rules for dispatching, such as voucher first, miles, etc., before cash/credit). The payment preparation orchestration instruction set 170 may include a balance inquiry module 176 that is configured to retrieve a loyalty account of a traveler (e.g., miles balance, tier list, and other loyalty account information). The payment preparation orchestration instruction set 170 may include a reward integration module 177 that is configured to compute various ranks needed to display and manage various functions and user interface elements in the payment preparation orchestration user interface, such as a reward slider for the user to select to pay partially in miles and partially in cash. The payment preparation orchestration instruction set 170 may include a user interface module 178 for generating and managing a payment preparation orchestration user interface (e.g., a front-end API such as a “payment page”) at a client device (e.g., from a travel provider server via a booking engine). The payment preparation orchestration instruction set 170 may include an authentication module 179 to verify a user making the payment on a client device via a merchant webpage from a reservation server.

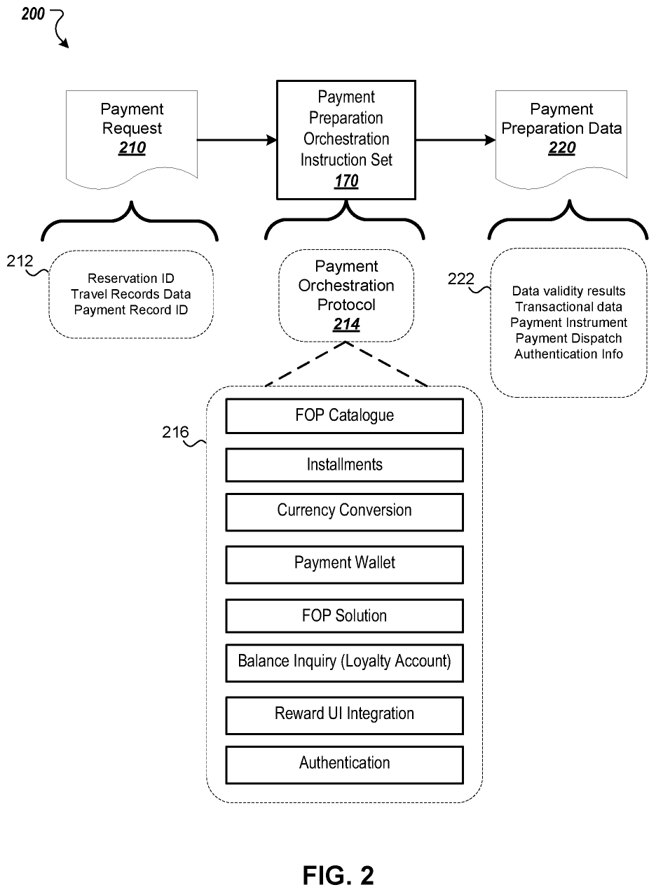

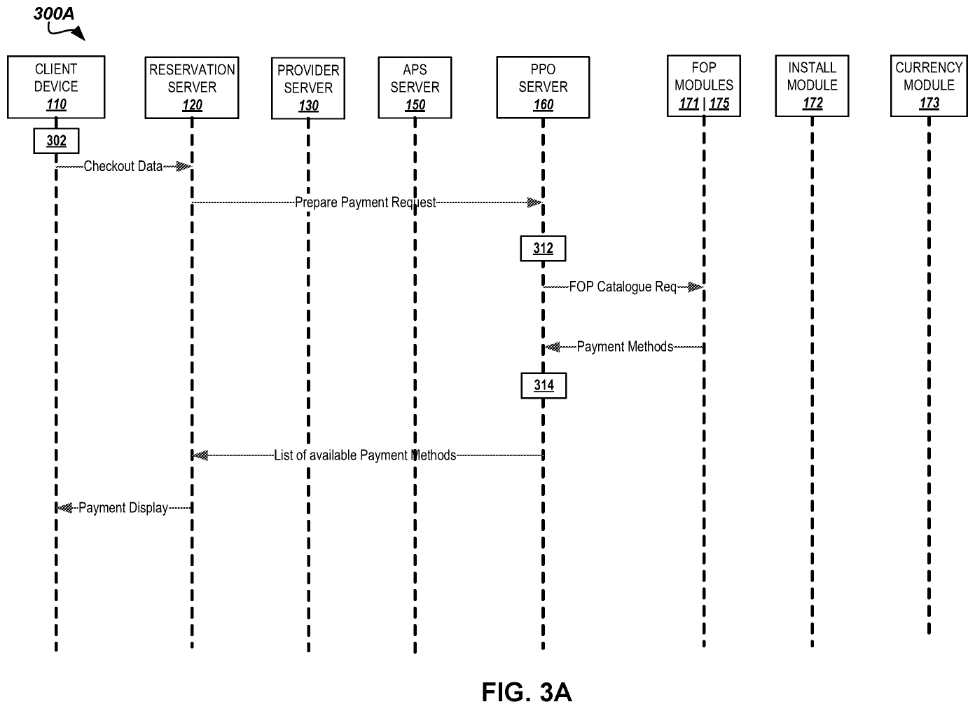

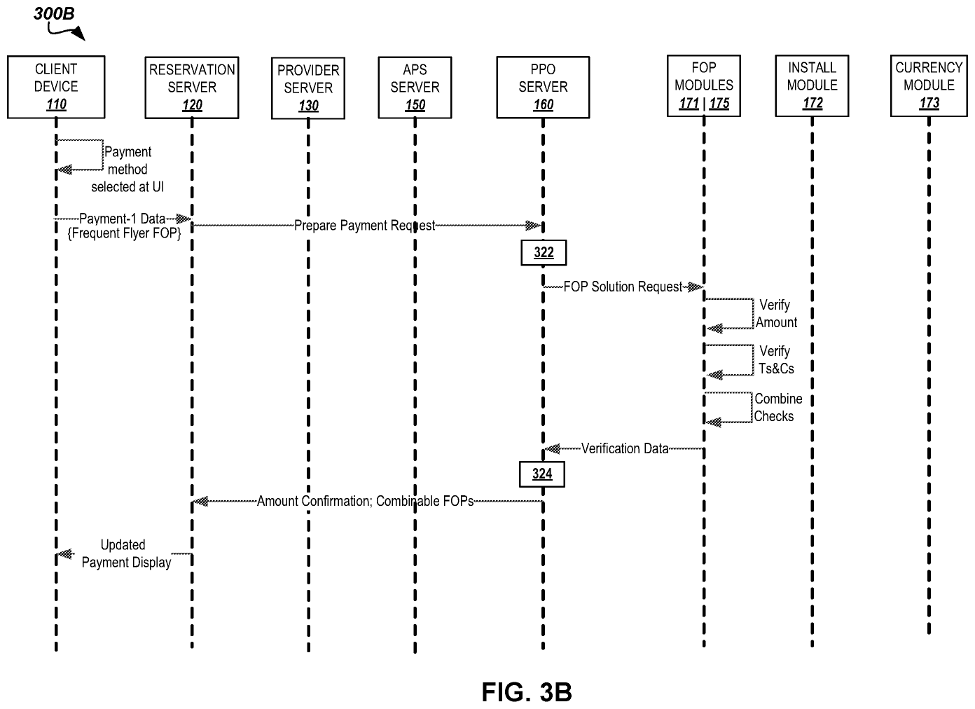

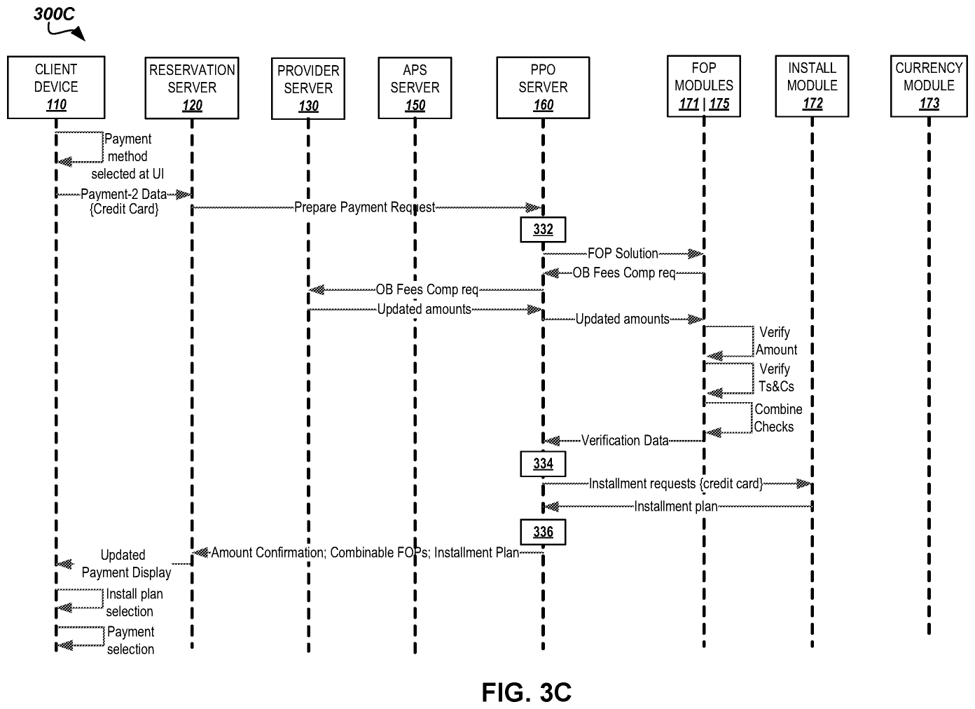

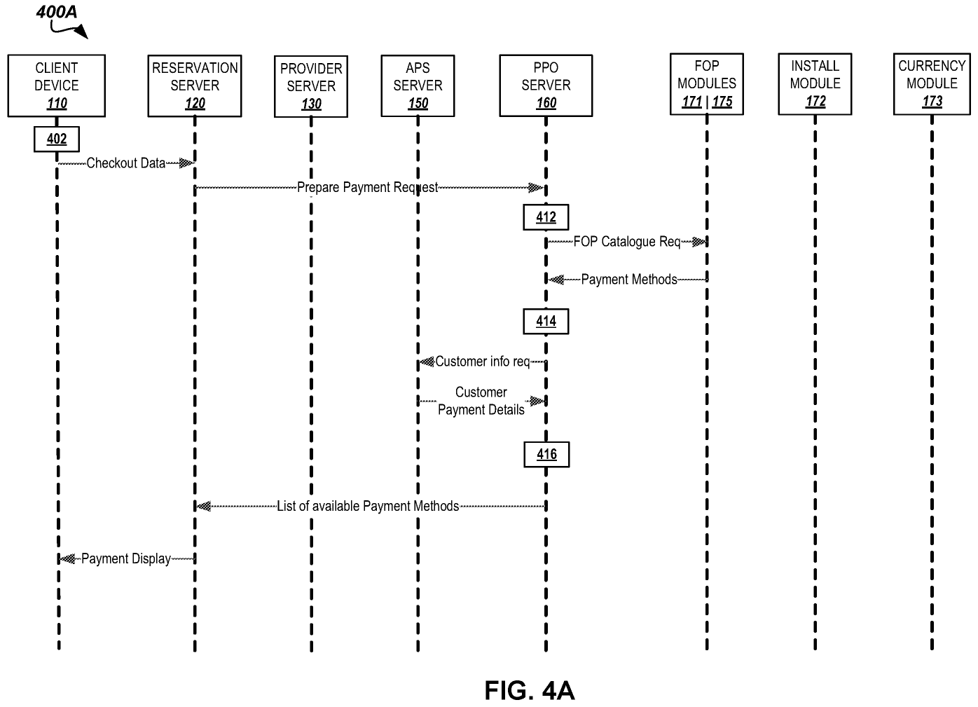

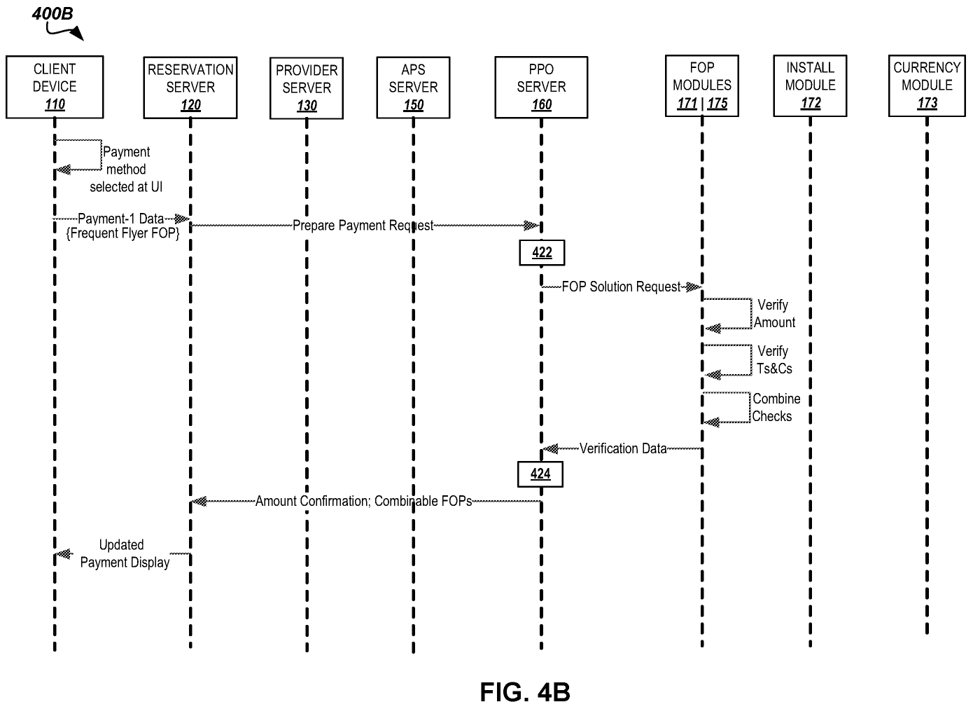

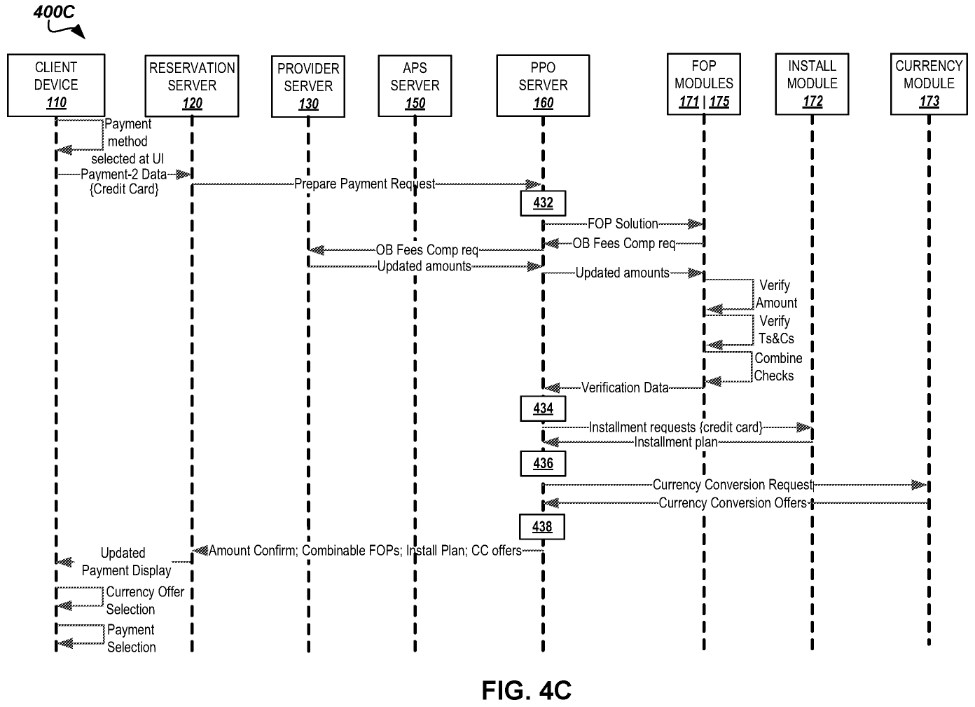

An example routine of implementing a payment preparation protocol as illustrated in the environment of FIG. 1 is further discussed herein with reference to the example environment of FIG. 2, and the sequence diagrams in FIGS. 3-4.

FIG. 2 illustrates an example payment preparation orchestration process based on a payment request, according to embodiments of the invention. In particular, FIG. 2 illustrates an example environment 200 for a payment preparation orchestration implementation for determining a payment preparation data 220 based on receiving a payment request 210. The objective for the payment preparation orchestration instruction set 170 is to implement a payment preparation orchestration process (e.g., a prepare payment service that includes a complex orchestration aspect on front-end side to be able to call the services in the right order and at the right time of the payment flow) utilizing one or more payment orchestration servers that are in communication with the travel providers, travel reservation systems, and payment processors via a payment platform gateway. For example, the payment preparation orchestration instruction set 170, stored on one or more payment preparation orchestration server(s) 160, receives a payment request 210 (e.g., from a client device 110). The payment request 210 includes payment request information 212 (e.g., travel/reservation ID, travel records data, payment record ID, etc.) that is associated with a travel reservation. In some implementations, the complete set of payment data is not in the request query (e.g., payment request information 212), however, the payment record ID allows the payment preparation orchestration instruction set 170 to identify the payment transaction in the database to retrieve all the related payment data.

The payment preparation orchestration instruction set 170 initiates a payment preparation protocol 214 to generate payment preparation data 220. The payment preparation protocol 214 includes, for example, one or more modules to perform a plurality of services. For example, the FOP catalogue module provides the list of eligible payment methods given the payment context (e.g., type of merchant, products, country, etc.). The installment module manages payments in several iterations. The currency conversion module manages payments in a different currency than the one initially proposed by the merchant. The payment wallet module retrieves the payment instruments stored in a payment wallet, such as user profile information (e.g., travel data), payment methods, vouchers, etc. The FOP solution module offers a dispatch of the payment instruments on the various products based on, for example, the products to buy, the payment instruments selected by the traveler, and the applicability constraints of both (e.g., different rules for dispatching, such as voucher first, miles, etc., before cash/credit). The balance inquiry module retrieves a loyalty account of a traveler (e.g., miles balance, tier list, and other loyalty account information). The user interface module generates and manages a payment preparation orchestration user interface (e.g., a front-end API such as a “payment page”) at a client device (e.g., from a travel provider server via a booking engine). The reward integration module computes various ranks needed to display and manage various functions and user interface elements in the payment preparation orchestration user interface, such as a reward slider for the user to select to pay partially in miles and partially in cash. The authentication module verifies a user making the payment on a client device via a merchant webpage from a reservation server.

The payment preparation data 220 may include payment preparation orchestration results data 222 such as data validity results, transactional data associated with the payment transaction, the payment instrument, payment dispatch information, and authentication information. An example illustration of implementing a payment preparation protocol as illustrated in FIG. 2 is further discussed herein with reference to the sequence diagrams of FIGS. 3 and 4.

FIG. 3A-3C illustrate example routines in the form of a sequence diagrams 300A-300C, respectively, that may be performed by the example operating environment shown in FIG. 1 as a procedure to facilitate a payment preparation orchestration process for a travel booking, according to embodiments of the invention. In particular, FIGS. 3A-3C illustrate a process for the same user/traveler that initiates payment process in FIG. 3A, chooses a first FOP to use in FIG. 3B (e.g., frequent flyer points), then selects another different FOP in FIG. 3C (e.g., credit card). FIGS. 3A-3C provide an exemplary routine that may be performed by the client device 110, the reservation server(s) 120, the travel provider server(s) 130, the payment gateway server(s) 140, the APS server(s) 150, the payment preparation orchestration server(s) 160 and/or one or more service modules associated with or standalone processor/servers (e.g., the submodules 171-179 of the payment preparation orchestration instruction set 170, such as FOP modules 171, 175, installment module 172, currency conversion module 173, etc.) consistent with some embodiments of the invention to prepare for a payment process for a travel booking via a payment preparation user interface (e.g., a front-end API such as a “payment page”).

FIG. 3A illustrates the sequence diagram 300A, which is initiated at block 302 at a client device 110 via application 112 (e.g., a checkout request associated with a travel request is entered at a consumer device that initiates a payment website). The checkout request data is received by a reservation server 120 (e.g., a booking engine). In response, the reservation server 120 generates and sends a prepare payment request to a payment preparation orchestration server 160. At block 312, the payment preparation orchestration server 160 via the payment preparation orchestration instruction set 170 determines, based on the checkout data associated with the travel request, to access the FOP catalogue module 171 to request available payment methods. For example, as illustrated in FIG. 3A, the payment preparation orchestration server 160 sends an FOP catalogue request to the FOP catalogue module 171 and receives the available payment method results. At block 314, the payment preparation orchestration server 160 receives available payment method results (e.g., credit cards, electronic payment services, frequent flyer, vouchers, or other alternative methods of payment) associated with the user for the checkout request. The payment preparation orchestration server 160 then provides a list of available payment methods to the reservation server 120. The reservation server 120 then provides the payment results for display at a payment page at the client device 110.

FIG. 3B illustrates the sequence diagram 300B, which is initiated at the client device 110 via application 112 when the user selects payment method at the user interface (e.g., from the list of payment results listed on the display from the end of the sequence diagram 300A of FIG. 3A). The selected payment instrument details (e.g., payment-1 data {Frequent Flyer FOP}) is sent by the client device 110 and received by the reservation server 120 (e.g., booking engine). For example, the user at the client device 110 has selected to initially pay for the travel event with frequent flyer miles. In response, the reservation server 120 generates and sends a prepare payment request with the selected FOP information (e.g., frequent flyer number information) to the payment preparation orchestration server 160. At block 322, the payment preparation orchestration server 160 via the payment preparation orchestration instruction set 170 determines, based on the payment-1 data associated with the travel request, to access the FOP solution module 175 to request an FOP solution check. For example, as illustrated in FIG. 3B, the payment preparation orchestration server 160 sends an FOP solution request to the FOP solution module 175. The FOP solution module 175 is configured to offer a dispatch of the payment instruments on the various products based on, for example, the products to buy, the payment instruments selected by the traveler, and the applicability constraints of both (e.g., different rules for dispatching, such as voucher first, miles, etc., before cash/credit). As illustrated in FIG. 3B, the FOP solution module 175 performs a sanity check via an amount verification step, a terms and conditions verification, and performs a combinability check to determine if different FOP can be combined. The FOP solution module 175 then compiles and sends the verification data to the payment preparation orchestration server 160.

The payment preparation orchestration server 160 receives the verification data, and at block 324, the payment preparation orchestration server 160 determines the payment method (e.g., in this example, frequent flyer miles was selected), determines the FOP amount and the monetary amounts missing (e.g., not enough frequent flyer miles) and whether the selected FOP is combinable with other FOPs (e.g., will the merchant allow combination of frequent flyer miles and other forms of payments). The payment preparation orchestration server 160 then provides amount confirmation and the combinable FOPs to the reservation server 120. The reservation server 120 then provides the updated amounts information results for display at a payment page at the client device 110, which may include a dropdown list for a second payment method (e.g., to combine a credit card transaction with frequent flyer miles).

FIG. 3C illustrates the sequence diagram 300C, which is initiated at the client device 110 via application 112 when the user selects a second payment method (e.g., a credit card) at the user interface (e.g., from the list of results listed on the display from the end of the sequence diagram 300B of FIG. 3B after choosing a first payment method-frequent flyer miles). The selected payment instrument details (e.g., payment-2 data {Credit Card FOP}) is sent by the client device 110 and received by the reservation server 120 (e.g., booking engine). For example, the user at the client device 110 has selected to combine payment for the travel event with frequent flyer miles and a credit card. In response, the reservation server 120 generates and sends a prepare payment request with the selected FOP information (e.g., credit card number information) to the payment preparation orchestration server 160. At block 332, the payment preparation orchestration server 160 via the payment preparation orchestration instruction set 170 determines, based on the payment-2 data associated with the travel request, to access the FOP solution module 175 to request an FOP solution check. For example, as illustrated in FIG. 3B, the payment preparation orchestration server 160 sends an FOP solution request to the FOP solution module 175. Because of the combined payment request, the FOP solution module 175 first sends an OB fee computation request to the payment preparation orchestration server 160 which sends the request to the travel provider server 130 (e.g., “OB Fees” are defined by IATA as the industry standard for ticketing and for the application of form of payment fees, including credit card fees). The travel provider server 130 then updates the amounts based on the determined OB Fees associated with the payment-2 data (e.g., credit card transaction), and sends to updated amounts back to the FOP solution module 175 via the payment preparation orchestration server 160. Then, as illustrated in FIG. 3B, the FOP solution module 175 performs a sanity check of the updated amounts via an amount verification step, a terms and conditions verification, and performs a combinability check to determine if different FOP can be combined. The FOP solution module 175 then compiles and sends the verification data to the payment preparation orchestration server 160.

The payment preparation orchestration server 160 receives the verification data, and at block 334, the payment preparation orchestration server 160 determines the payment method (e.g., in this example, credit card was selected), and then provides an installment request to the installment module 172. The installment module 172 then generates and provides installment plan options data to the payment preparation orchestration server 160. At block 336, the payment preparation orchestration server 160 obtains the installment plan data and then provides the amount confirmation, the combinable FOPs, and the installment plan to the reservation server 120. The reservation server 120 then provides the updated amounts information results and the installment plan selection for display at a payment page at the client device 110, which includes a selection for the user to select an installment plan. After receiving a selection of the installment plan at the client device 110, the user then is provided options to confirm payment, which in turn initiates a payment flow process (e.g., to combine a credit card transaction that includes an installment plan (if applicable) with frequent flyer miles).

The actions of the payment preparation orchestration server(s) 160 utilizing the payment preparation orchestration instruction set 170 to process a payment preparation protocol are further described herein with reference to another example in the sequence diagrams in FIGS. 4A-4C.

FIG. 4A-4C illustrate example routines in the form of a sequence diagrams 400A-400C, respectively, that may be performed by the example operating environment shown in FIG. 1 as a procedure to facilitate a payment preparation orchestration process for a travel booking, according to embodiments of the invention. In particular, FIGS. 4A-4C illustrate a process for the same user/traveler that initiates payment process in FIG. 4A, chooses a first FOP to use in FIG. 4B (e.g., frequent flyer points), then selects another different FOP in FIG. 4C (e.g., credit card). FIGS. 4A-4C provide an exemplary routine that may be performed by the client device 110, the reservation server(s) 120, the travel provider server(s) 130, the payment gateway server(s) 140, the APS server(s) 150, the payment preparation orchestration server(s) 160 and/or one or more service modules associated with or standalone processor/servers (e.g., the submodules 171-179 of the payment preparation orchestration instruction set 170, such as FOP modules 171, 175, installment module 172, currency conversion module 173, etc.) consistent with some embodiments of the invention to prepare for a payment process for a travel booking via a payment preparation user interface (e.g., a front-end API such as a “payment page”).

FIG. 4A illustrates the sequence diagram 400A, which is initiated at block 402 at a client device 110 via application 112 (e.g., a checkout request associated with a travel request is entered at a consumer device that initiates a payment website). The checkout request data is received by a reservation server 120 (e.g., a booking engine). In response, the reservation server 120 generates and sends a prepare payment request to a payment preparation orchestration server 160. At block 412, the payment preparation orchestration server 160 via the payment preparation orchestration instruction set 170 determines, based on the checkout data associated with the travel request, to access the FOP catalogue module 171 to request available payment methods. For example, as illustrated in FIG. 4A, the payment preparation orchestration server 160 sends an FOP catalogue request to the FOP catalogue module 171 and receives the available payment method results. At block 414, the payment preparation orchestration server 160 receives available payment method results (e.g., credit cards, electronic payment services, frequent flyer, vouchers, or other alternative methods of payment) associated with the user for the checkout request and sends a customer information request to the APS server 150. The APS server 150 provides customer payment details (e.g., “traveler information” such as saved payment details associated with a particular payment provider) to the payment preparation orchestration server 160. At block 416, the payment preparation orchestration server 160 receives customer payment details from the APS server 150 and then provides a list of available payment methods to the reservation server 120. The reservation server 120 then provides the payment results for display at a payment page at the client device 110.

FIG. 4B illustrates the sequence diagram 400B, which is initiated at the client device 110 via application 112 when the user selects payment method at the user interface (e.g., from the list of payment results listed on the display from the end of the sequence diagram 400A of FIG. 4A). The selected payment instrument details (e.g., payment-1 data {Frequent Flyer FOP}), as well as the customer payment details (e.g., “traveler information”), is sent by the client device 110 and received by the reservation server 120 (e.g., booking engine). For example, the user at the client device 110 has selected to initially pay for the travel event with frequent flyer miles. In response, the reservation server 120 generates and sends a prepare payment request with the selected FOP information (e.g., frequent flyer number information) to the payment preparation orchestration server 160. At block 422, the payment preparation orchestration server 160 via the payment preparation orchestration instruction set 170 determines, based on the payment-1 data associated with the travel request and based on the customer payment details (e.g., “traveler information”), to access the FOP solution module 175 to request an FOP solution check. For example, as illustrated in FIG. 4B, the payment preparation orchestration server 160 sends an FOP solution request to the FOP solution module 175. The FOP solution module 175 is configured to offer a dispatch of the payment instruments on the various products based on, for example, the products to buy, the payment instruments selected by the traveler, and the applicability constraints of both (e.g., different rules for dispatching, such as voucher first, miles, etc., before cash/credit). As illustrated in FIG. 4B, the FOP solution module 175 performs a sanity check via an amount verification step, a terms and conditions verification, and performs a combinability check to determine if different FOP can be combined. The FOP solution module 175 then compiles and sends the verification data to the payment preparation orchestration server 160.

The payment preparation orchestration server 160 receives the verification data, and at block 424, the payment preparation orchestration server 160 determines the payment method (e.g., in this example, frequent flyer miles was selected), determines the FOP amount and the monetary amounts missing (e.g., not enough frequent flyer miles) and whether the selected FOP is combinable with other FOPs (e.g., will the merchant allow combination of frequent flyer miles and other forms of payments). The payment preparation orchestration server 160 then provides amount confirmation and the combinable FOPs to the reservation server 120. The reservation server 120 then provides the updated amounts information results for display at a payment page at the client device 110, which may include a dropdown list for a second payment method (e.g., to combine a credit card transaction with frequent flyer miles).

FIG. 4C illustrates the sequence diagram 400C, which is initiated at the client device 110 via application 112 when the user selects a second payment method (e.g., a credit card) at the user interface (e.g., from the list of results listed on the display from the end of the sequence diagram 400B of FIG. 4B after choosing a first payment method-frequent flyer miles). The selected payment instrument details (e.g., payment-2 data {Credit Card FOP}) is sent by the client device 110 and received by the reservation server 120 (e.g., booking engine). For example, the user at the client device 110 has selected to combine payment for the travel event with frequent flyer miles and a credit card. In response, the reservation server 120 generates and sends a prepare payment request with the selected FOP information (e.g., credit card number information) to the payment preparation orchestration server 160. At block 432, the payment preparation orchestration server 160 via the payment preparation orchestration instruction set 170 determines, based on the payment-2 data associated with the travel request, to access the FOP solution module 175 to request an FOP solution check. For example, as illustrated in FIG. 4B, the payment preparation orchestration server 160 sends an FOP solution request to the FOP solution module 175. Because of the combined payment request, the FOP solution module 175 first sends an OB fee computation request to the payment preparation orchestration server 160 which sends the request to the travel provider server 130 (e.g., “OB Fees” are defined by IATA as the industry standard for ticketing and for the application of form of payment fees, including credit card fees). The travel provider server 130 then updates the amounts based on the determined OB Fees associated with the payment-2 data (e.g., credit card transaction), and sends to updated amounts back to the FOP solution module 175 via the payment preparation orchestration server 160. Then, as illustrated in FIG. 4B, the FOP solution module 175 performs a sanity check of the updated amounts via an amount verification step, a terms and conditions verification, and performs a combinability check to determine if different FOP can be combined. The FOP solution module 175 then compiles and sends the verification data to the payment preparation orchestration server 160.

The payment preparation orchestration server 160 receives the verification data, and at block 434, the payment preparation orchestration server 160 determines the payment method (e.g., in this example, credit card was selected), and then provides an installment request to the installment module 172. The installment module 172 then generates and provides installment plan options data to the payment preparation orchestration server 160. At block 436, the payment preparation orchestration server 160 obtains the installment plan data, and then provides a currency conversion request to the currency conversion module 173. currency conversion module 173 then generates and provides currency conversion offers data to the payment preparation orchestration server 160. At block 438, the payment preparation orchestration server 160 obtains the currency conversion offers from the currency conversion module 173 and then provides the amount confirmation, the combinable FOPs, the installment plan, and the currency conversion offers to the reservation server 120. The reservation server 120 then provides the updated amounts information results, the installment plan, and the and the currency conversion offers for display at a payment page at the client device 110, which includes a selection for the user to select an installment plan and/or a currency conversion offer. After receiving a selection of the installment plan and/or a currency conversion offer at the client device 110, the user then is provided options to confirm payment, which in turn initiates a payment flow process (e.g., to combine a credit card transaction that includes an installment plan (if applicable) with frequent flyer miles) along with the associated/selected installment plan (if applicable) and/or currency conversion offer (if applicable).

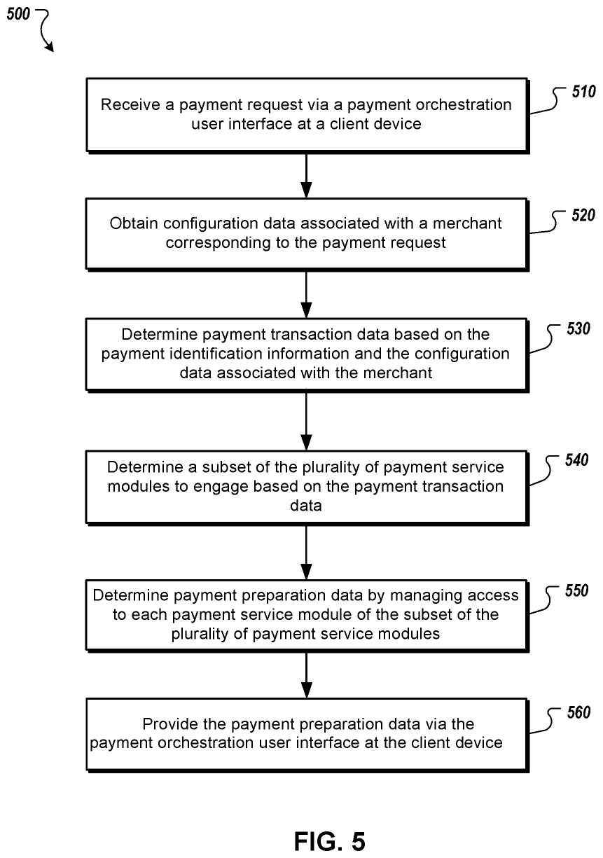

The actions of the payment preparation orchestration server(s) 160 utilizing the payment preparation orchestration instruction set 170 to process a payment preparation protocol are further described herein with reference to a method flowchart in FIG. 5.

FIG. 5 illustrates a flowchart of an example process 500 for updating a payment preparation user interface based on a payment request, according to embodiments of the invention. Operations of the process 500 can be implemented, for example, by a system that includes one or more data processing apparatus, such as one or more payment preparation orchestration server(s) 160 of FIG. 1 utilizing a payment preparation orchestration instruction set 170. The process 500 can also be implemented by instructions stored on computer storage medium, where execution of the instructions by a system that includes a data processing apparatus cause the data processing apparatus to perform the operations of the process 500.

The system receives a payment request via a payment orchestration user interface at a client device (510). In some implementations, the payment request is encoded with payment identification information, and the payment orchestration user interface provides access to a plurality of payment processor servers and a plurality of payment service modules (e.g., the submodules 171-179 of the payment preparation orchestration instruction set 170 of FIG. 1). In some implementations, the payment request is received at a front-end API (e.g., a “payment page”) at a client device (e.g., from a travel provider server via a booking engine). For example, as illustrated in each of the sequence diagrams of FIGS. 3 and 4, the client device 110 initiates a checkout request (e.g., a payment request) to the reservation server 120. In some implementations, the payment request is associated with a travel booking request. In some implementations, the payment request is received from a travel provider server via a booking engine. A payment identification may be associated with a travel record identification pertaining to the checkout request. The reservation system (e.g., reservation server 120) processed the travel record identification.

The system obtains configuration data associated with a merchant corresponding to the payment request (520). For example, as illustrated in each of the sequence diagrams of FIGS. 3 and 4, the reservation server 120, initiates a payment preparation protocol by communicating a prepare payment request to one of the payment preparation orchestration servers 160. In some implementations, the configuration data associated with the merchant corresponding to the payment request includes payment rules. For example, the configuration data may include an internal configuration of the particular merchant associated with the reservation server 120, such as payment rules, i.e., vouchers before loyalty points/miles.

The system determines payment transaction data based on the payment identification information and the configuration data associated with the merchant (530). For example, the payment preparation orchestration server 160 receives the prepare payment request from the reservation server 120, and the payment preparation orchestration server 160 may be able to decode the request (e.g., determine the specific configuration data associated with the client and the merchant for the particular engagement/payment request).

The system determines a subset of the plurality of payment service modules to engage based on the payment transaction data (540). For example, the payment preparation orchestration server 160 via the payment preparation orchestration instruction set 170 may determine which of the micro-services (e.g., the submodules 171-179 of the payment preparation orchestration instruction set 170) to access for the particular request.

The system determines payment preparation data by managing access to each payment service module of the subset of the plurality of payment service modules (550). For example, as illustrated in one or more of the sequence diagrams of FIGS. 3 and 4, the payment preparation orchestration servers 160 determines which of the plurality of payment service modules, aka, micro-services (e.g., submodules 171-179) to access to proceed with the payment preparation protocol. In some implementations, the payment preparation data includes at least one or more of payment orchestration data, payment instruments, traveler related data (e.g., specific card numbers, online payment accounts, etc.) and/or payment options associated with the payment request (e.g., installments, currency conversion, and the like).

In some implementations, the plurality of payment service modules includes an FOP solution module (e.g., FOP solution module 175), which is configured to offer a dispatch of payment instruments for various products associated with the payment request based on products to buy, the payment instruments selected by the traveler, and applicability constraints. For example, the FOP solution module may determine an association with both the products to buy and the payment instruments selected by the traveler (e.g., different rules for dispatching, such as voucher first, miles, etc. before cash/credit).

The system provides the payment preparation data via the payment orchestration user interface at the client device (560). For example, the front-end API (e.g., “payment page”) at the client device receives and displays the payment options and the user can than make a selection and proceed with payment.

In some implementations, prior to providing the view of the payment preparation data, performing a validation process to verify each of the accessed payment service modules of the plurality of payment service modules were correctly selected. For example, the process 500 may be able to check for errors during the payment preparation orchestration process and go back to a same or a different payment service module based on a detected error (e.g., issues may be caused previously by users who go back/forth with vouchers, miles, cash, installments, etc.).

In some implementations of the invention, a process for a form of payment may be orchestrated. For example, a form of payment orchestration process may integrate a plurality of front-end services to prepare a system for payment, and thus require a complex orchestration aspect on front-end side to be able to call the services in the right order and at the right time of the payment flow. The form of payment service seeks to solve this orchestration problem for the front-end, centralizing the orchestration logic, and overcome significant technical obstacles. For example, one technical obstacle includes identifying properly the different use cases on the payment side to trigger a correct orchestration sequence (e.g., payment modifications, partial payments, installments, BIN verifications, reward integration, alternate currency, and the like). Another technical obstacle includes properly orchestrating those various operations depending on the payment instruments in the query and the PNR content. Another technical obstacle includes storing, in a secured manner, all of the payment details for the feeds and with respect to Payment Card Industry Data Security Standards (PCI-DSS) security audit constraints (e.g., after the payment and all needed operations have been processed).

Electronic Data Interchange for Administration, Commerce, and Transport (EDIFACT) is an international standard for electronic data interchange (EDI). In embodiments of the invention, an EDIFACT API is utilized that may be provided to a front-end payment service that may allow the payment process to benefit from connectivity with a plurality of payment related services with an easy integration. The API may provide a better experience to a user/traveler in terms of authentication of the form of payment steps (e.g., payment modifications, partial payments, installments, BIN verifications, reward integration, alternate currency, etc.), because there is only one API to integrate which handles the orchestration and the calls to various micro-services in order to make sure everything is ready to perform the payment, especially to make sure that the amount is the correct one (e.g., authentication and verification). Then payment request is performed before creating a form of payment element in the PNR (e.g., an “FP element”) to ensure payment is properly reported and securely stored. For example, storing payment data in the PNR by adding new lines in an EDIFACT message (e.g., the PASBCQ, which is the EDIFACT representation of the PNR). Once stored in the PASBCQ, which is saved in the PNR database, this hidden data is read during the issuance process by FOP application to generate the reporting data that will be reported in the ticket emitted during this issuance process. One PASBCQ represents a PNR, FOP application creates a FP element in an EDIFACT message by adding new lines inside, and part of those lines are the hidden data, or the credit card data, etc. This data may be encoded when needed and stored in a secure PNR database.

In an exemplary embodiment for a form of payment orchestration process, an API query is encoded by a booking engine associated with a merchant (e.g., an airline) and sent to and decoded by a payment orchestration server (e.g., EDIFACT API encoding/decoding). The form of payment orchestration server, based on the decoded input and on an internal configuration of the merchant associated with the booking engine, a series of services will be called in order to perform processes and gather data. The created form of payment data, and part of the associated data, if any, once payment is completed, may then be encoded in the API response.

In some embodiments of the invention for a form of payment orchestration process, the different series of services include one or more FOP service modules. The FOP service modules may include a FOP orchestrator module manages the FOP orchestration process and the requests to the various micro-services (e.g., FOP service modules) in order to make sure everything is ready to perform the payment. The FOP service modules may include a pricing module that is configured to determine if there are multiple passengers for one booking (e.g., one ticket issued per passenger, thus if two passengers/travelers, determine two authorization requests, and depending on the way the itinerary has been priced and the way the payment is performed, there may be the need to trigger a split to cover the proper passenger association). The FOP service modules may include a BIN verification module that is configured to ensure that a credit card number provided (or other means of payment) matches with the vendor selected by the front-end payment interface. The FOP service modules may include a reward integration module that is configured to receive a reward ranking selection based on a reward slider in a client user interface to pay partially in miles and partially in cash in order to verify the exact miles and revenue amounts from pricing application based on the selected rank. The FOP service modules may include an installment module that is configured to manage payments in several iterations. The FOP service modules may include an alternative currency module that is configured to manage payments in a different currency than the one initially proposed by the merchant, where additional information decoded in an API query may be transferred to a payment partner for correct processing. The FOP service modules may include a secure storage module that is configured to manage the storage of all of the payment details associated with the FOP request and storing the data in a secured manner with respect to security audit constraints. The FOP service modules may include an authentication module to verify a user making the payment on a client device via a merchant webpage from a reservation server.

More specifically, this technology for the form of payment orchestration process includes a process that receives a form of payment (FOP) request via a FOP orchestration service (e.g., a front-end EDIFACT/API) from a merchant device (e.g., from a merchant/travel provider server). The FOP request is encoded with payment identification information, and the FOP orchestration service provides access to one or more payment processor servers, a plurality of FOP service modules (e.g., pricing-TST, BIN, installments, rewards, etc.), and a payment security database. The process further obtains user data (PNR content) associated with a transaction (travel event/booking request for a user/traveler) corresponding to the FOP request (e.g., internal configuration of the merchant, such as payment rules, i.e., vouchers before loyalty points/miles). The process further determines payment transaction data (e.g., payment instruments from the query) based on the payment identification information and the user data (PNR content) and may be configured to decode the request). The process further determines payment authorization data (e.g., FOP orchestration data, payment instruments, traveler related data (specific card numbers, online banking/payment accounts, etc.) or payment options (installments, alternative currency), rewards, etc.) by managing access to one or more of the plurality of FOP service modules based on the payment transaction data (e.g., determine which of the micro-services to access for the particular request, claim the process for access to each FOP service module). The process further provides a payment authorization request to a payment platform server based on the payment authorization data (e.g., customizing/encoding the authorization request based on the optional services needed such as installments, currency, and the like). The process further receives payment authorization data from the payment platform server. The process further stores the payment authorization data in a security payment database based on a FOP security protocol (e.g., storing in a secured manner all the payment details for the feeds and with respect to PCI-DSS security audit constraints). The process further provides the payment authorization data at the merchant device (e.g., to the travel provider system) via the FOP orchestration service (e.g., a front-end EDIFACT/API).

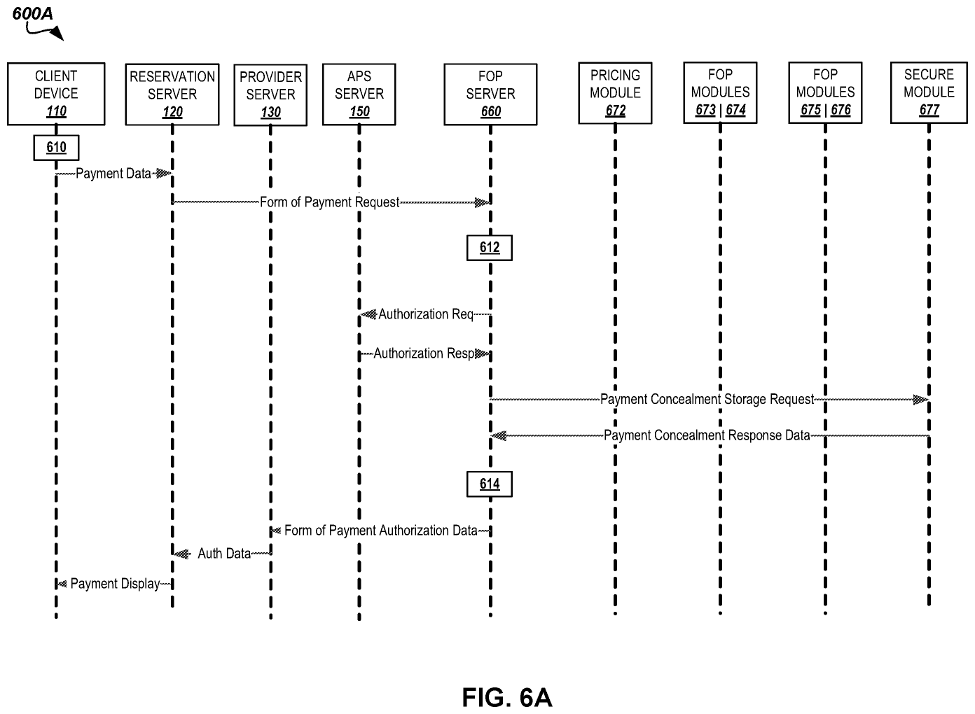

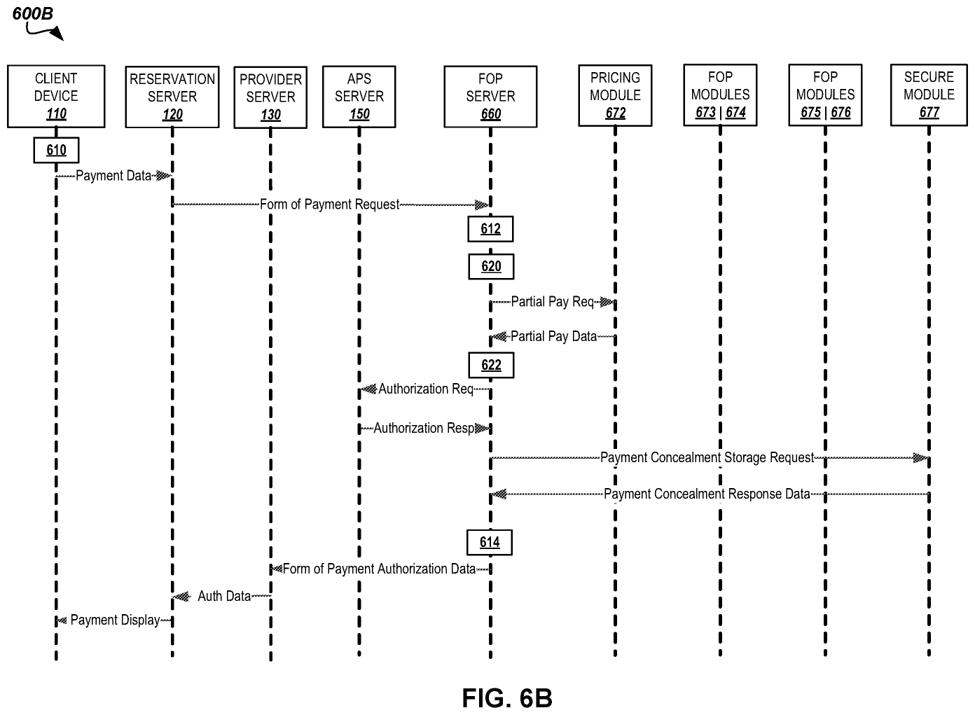

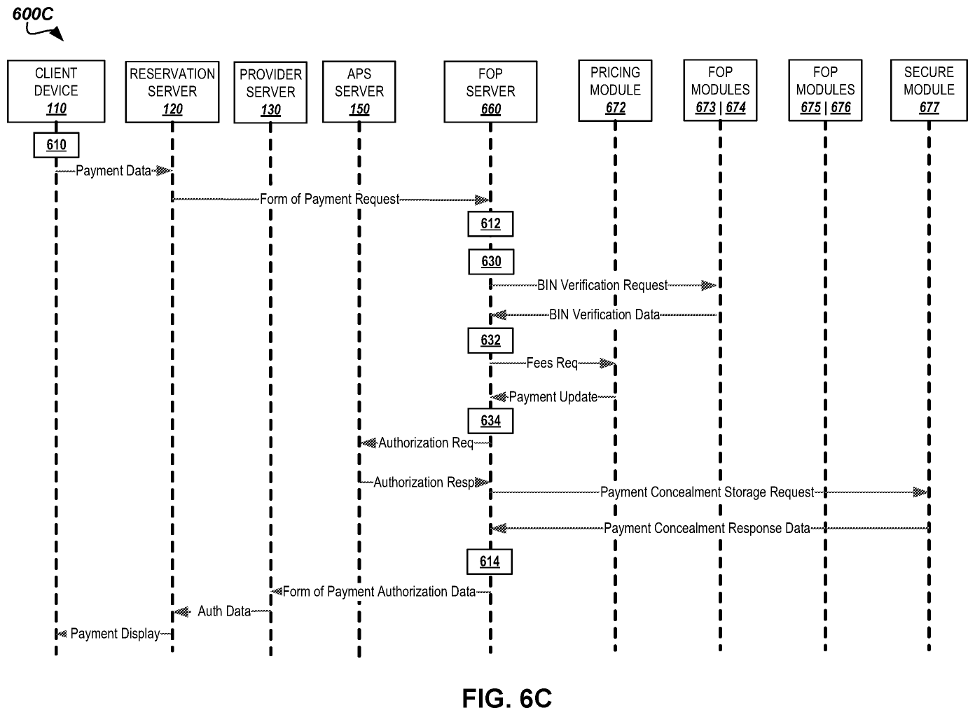

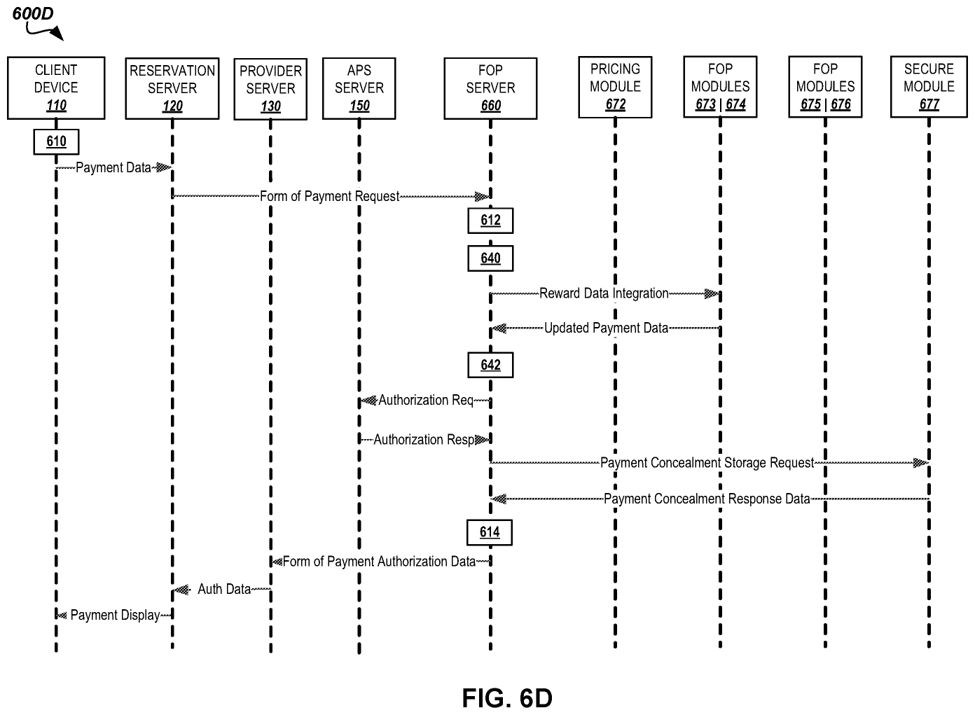

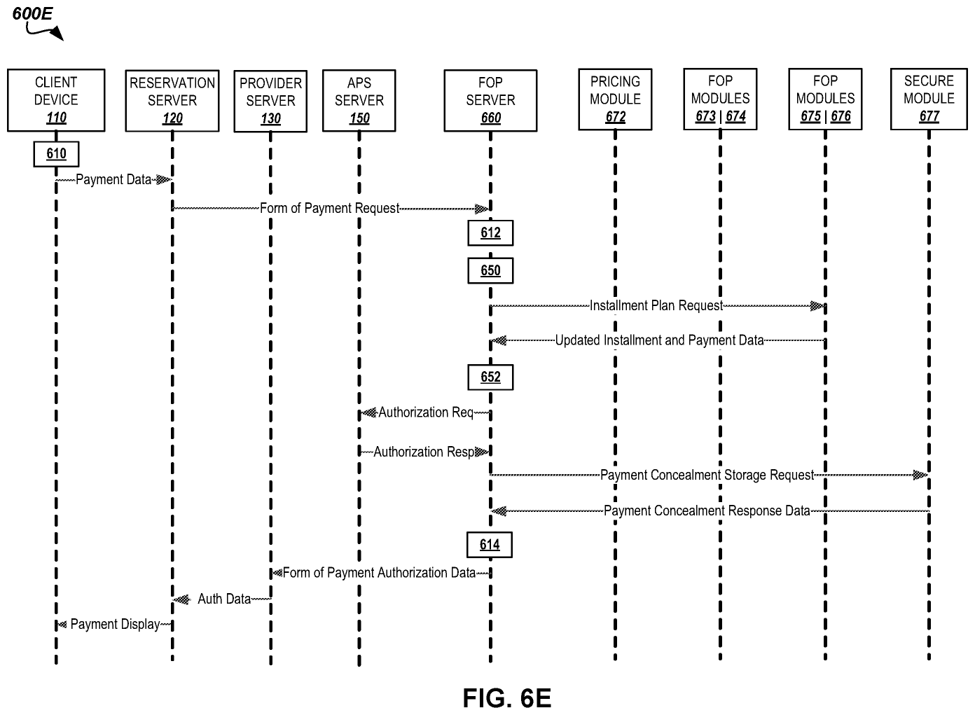

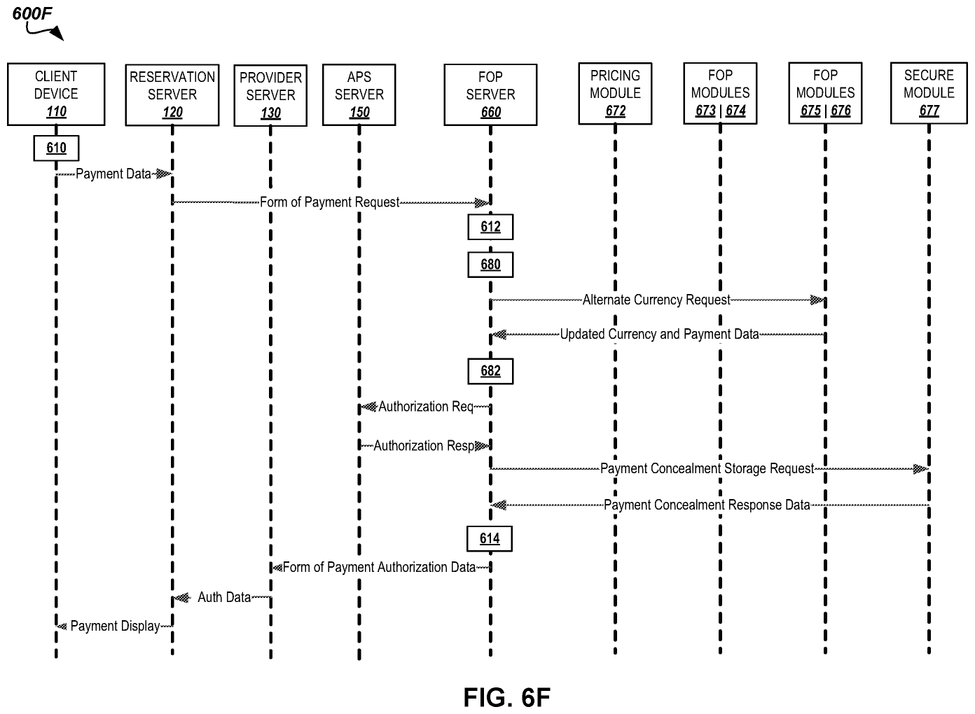

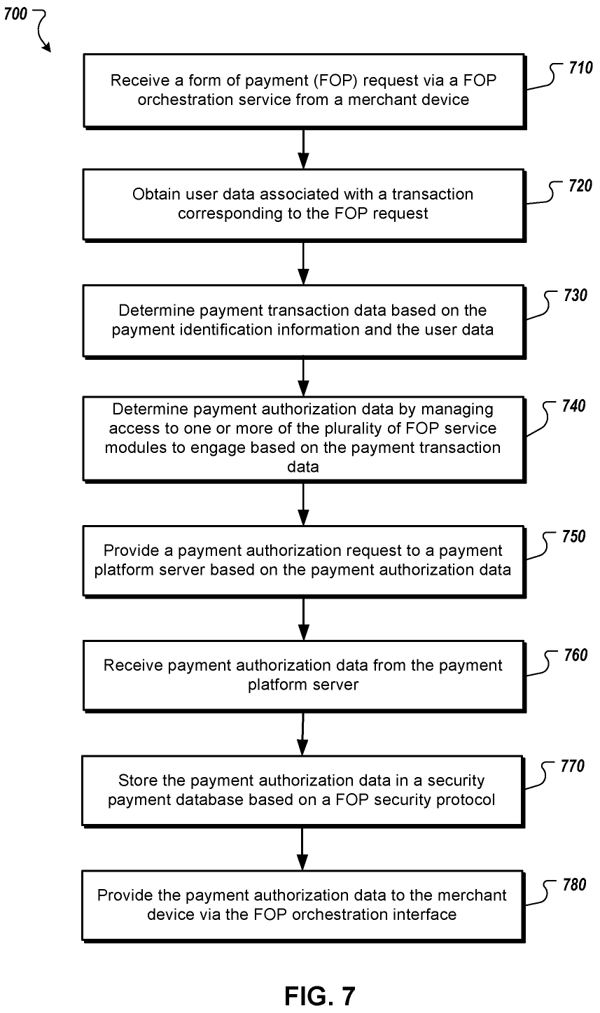

In some implementations, for a form of payment orchestration process, results data may include data validity results, transactional data associated with the payment transaction, BIN verification data, the payment instrument, authentication information, and security constraint information for secure storage. An example illustration of implementing a form of payment protocol is further discussed herein with reference to the sequence diagrams of FIGS. 6A-6F and the flowchart of an example process 700 of FIG. 7 for implementing and providing a form of payment orchestration process.

FIG. 6A-6F illustrate example routines in the form of a sequence diagrams 600A-600F, respectively, that may be performed by the example operating environment shown in FIG. 1 as a procedure to facilitate a form of payment orchestration process for a travel booking, according to embodiments of the invention. In particular, FIGS. 6A-6F illustrate a process for the same user/traveler that initiates a form of payment process with a merchant (e.g., a reservation server 120, or alternatively the travel provider server 130) in order to verify and authorize the form of payment associated with the travel booking. In particular, FIG. 6A provides the steps to initiate the form of payment process without options (e.g., partial payment, credit card verification, frequent flyer points, installment plans, alternative currency, etc.). Moreover, FIG. 6B illustrates a partial payment option, FIG. 6C illustrates a credit card verification process, FIG. 6D illustrates a travel rewards selection (e.g., frequent flyer points), FIG. 6E illustrates an installment plan option, and FIG. 6F illustrates an alternative currency option. FIGS. 6A-6F provide an exemplary routine that may be performed by the client device 110, the reservation server(s) 120, the travel provider server(s) 130, the payment gateway server(s) 140, and the APS server(s) 150. Additionally, the payment orchestration server(s) 160 may also include or form of payment orchestration server(s) 660 or the form of payment orchestration server(s) 660 may be standalone servers. The form of payment orchestration server(s) 660 may include one or more FOP service modules associated with or standalone processor/servers. For example, the submodules 671-678 of a form of payment orchestration instruction set 670, such as the FOP orchestrator module 671, the pricing module 672, the BIN verification module 673, the reward integration module 674, the installment module 675, the alternative currency module 676, the secure storage module 677, the authentication module 678, and/or other modules discussed herein or may otherwise be appropriate) consistent with some embodiments of the invention to prepare for a form of payment process for a travel booking.

FIG. 6A illustrates the sequence diagram 600A, which is initiated at the client device 110 via application 112 when the user selects a form of payment method (e.g., a credit card, online bank account, frequent flyer miles, etc.) at a user interface. The selected payment instrument details (e.g., payment data {Credit Card FOP}) is sent by the client device 110 and received by the reservation server 120 (e.g., a booking engine). For example, for FIG. 6A, the user at the client device 110 may have selected a form of payment that does not require additional options (e.g., a stored balance associated with the user, thus additional payment from a credit card, etc., is not needed). In response, the reservation server 120 generates and sends a form of payment request with the selected FOP information (e.g., payment information, such as credit card number information) to the form of payment orchestration server 660. At block 612, the form of payment orchestration server 660 via the form of payment orchestration instruction set 670 determines, via the FOP orchestrator module 671 and based on the form of payment data associated with a travel request/booking, whether or not additional modules are needed for different options.

Since no options are necessary for the example illustrated in FIG. 6A, the form of payment process proceeds with the FOP orchestration server 660 generating and sending an authorization request to the APS server 150. The APS server 150 receives the authorization request and the form of payment data and provides an authorization response the FOP orchestration server 660 on approval to proceed. If approved, the FOP orchestration server 660 then provides a payment concealment storage request to the secure storage module 677 that in turn stores the payment data and provides payment concealment response data that may include associated encryption data for the particular payment transaction. After receiving the payment concealment response data from the secure storage module 677, the FOP orchestration server 660, at block 614, generates an FP element associated with the form of payment and transaction data, securely stores the payment data in the PNR. The FOP orchestration server 660 then provides form of payment authorization data to the travel provider server 130 and/or reservation server 120 regarding the execution of payment based on the user selected form of payment. The reservation server 120 may then provide the payment results for display at a payment page at the client device 110.

FIG. 6B illustrates the sequence diagram 600B, which is initiated at the client device 110 via application 112 when the user selects a form of payment method (e.g., a credit card, online bank account, frequent flyer miles, etc.) at a user interface. The selected payment instrument details (e.g., payment data {Credit Card FOP}) is sent by the client device 110 and received by the reservation server 120 (e.g., a booking engine). For example, for FIG. 6B, the user at the client device 110 may have selected a form of payment that requires a partial payment for multiple passengers for a single booking request (e.g., one ticket issued per passenger, thus if two passengers/travelers, determine two authorization requests, and depending on the way the itinerary has been priced and the way the payment is performed, there may be the need to trigger a split to cover the proper passenger association). In response, the reservation server 120 generates and sends a form of payment request with the selected FOP information (e.g., payment information, such as credit card number information) to the form of payment orchestration server 660. At block 612, the form of payment orchestration server 660 via the form of payment orchestration instruction set 670 determines, via the FOP orchestrator module 671 and based on the form of payment data associated with a travel request/booking, whether or not additional modules are needed for different options. Because there is more than one passenger, a partial payment option is necessary for the example illustrated in FIG. 6B. Thus, at block 620, the FOP orchestrator module 671 at the FOP orchestration server 660 determines to utilize and send a partial payment request to the pricing module 672. The pricing module 672 then executes the partial payment request and returns partial payment data to the FOP orchestration server 660 with instructions on determining a number of authorization requests (e.g., two passengers may require two authorizations), and depending on the way the itinerary has been priced and the way the payment is performed, there may be the need to trigger a split to cover the proper passenger association.

At block 622, in response to the instructions received with the partial payment data from the pricing module 672, the form of payment process proceeds with the FOP orchestration server 660 generating and sending an authorization request to the APS server 150. The APS server 150 receives the authorization request and the form of payment data and provides an authorization response the FOP orchestration server 660 on approval to proceed. If approved, the FOP orchestration server 660 then provides a payment concealment storage request to the secure storage module 677 that in turn stores the payment data and provides payment concealment response data that may include associated encryption data for the particular payment transaction. After receiving the payment concealment response data from the secure storage module 677, the FOP orchestration server 660, at block 614, generates an FP element associated with the form of payment and transaction data, securely stores the payment data in the PNR. The FOP orchestration server 660 then provides form of payment authorization data to the travel provider server 130 and/or reservation server 120 regarding the execution of payment based on the user selected form of payment. The reservation server 120 may then provide the payment results for display at a payment page at the client device 110.

FIG. 6C illustrates the sequence diagram 600C, which is initiated at the client device 110 via application 112 when the user selects a form of payment method (e.g., a credit card, online bank account, frequent flyer miles, etc.) at a user interface. The selected payment instrument details (e.g., payment data {Credit Card FOP}) is sent by the client device 110 and received by the reservation server 120 (e.g., a booking engine). For example, for FIG. 6C, the user at the client device 110 may have selected a credit card as the form of payment that requires a BIN verification. In response, the reservation server 120 generates and sends a form of payment request with the selected FOP information (e.g., payment information, such as credit card number information) to the form of payment orchestration server 660. At block 612, the form of payment orchestration server 660 via the form of payment orchestration instruction set 670 determines, via the FOP orchestrator module 671 and based on the form of payment data associated with a travel request/booking, whether or not additional modules are needed for different options. Because a credit card was selected, a BIN verification is necessary for the example illustrated in FIG. 6C. Thus, at block 630, the FOP orchestrator module 671 at the FOP orchestration server 660 determines to utilize and send a BIN verification request to the BIN verification module 673. The BIN verification module 173 then executes the BIN verification request and returns BIN verification data to the FOP orchestration server 660. The FOP orchestration server 660 then sends an OB fee computation request to the pricing module 672 (e.g., “OB Fees” are defined by IATA as the industry standard for ticketing and for the application of form of payment fees, including credit card fees). The pricing module 672 then updates the amounts based on the determined OB fees associated with the payment data (e.g., credit card transaction), and sends to updated amounts back to the FOP orchestration server 660 via the FOP orchestrator module 671.

At block 634, in response to the updated fees from the pricing module 672, the form of payment process proceeds with the FOP orchestration server 660 generating and sending an authorization request to the APS server 150. The APS server 150 receives the authorization request and the form of payment data and provides an authorization response the FOP orchestration server 660 on approval to proceed. If approved, the FOP orchestration server 660 then provides a payment concealment storage request to the secure storage module 677 that in turn stores the payment data and provides payment concealment response data that may include associated encryption data for the particular payment transaction. After receiving the payment concealment response data from the secure storage module 677, the FOP orchestration server 660, at block 614, generates an FP element associated with the form of payment and transaction data, securely stores the payment data in the PNR. The FOP orchestration server 660 then provides form of payment authorization data to the travel provider server 130 and/or reservation server 120 regarding the execution of payment based on the user selected form of payment. The reservation server 120 may then provide the payment results for display at a payment page at the client device 110.

FIG. 6D illustrates the sequence diagram 600D, which is initiated at the client device 110 via application 112 when the user selects a form of payment method (e.g., a credit card, online bank account, frequent flyer miles, etc.) at a user interface. The selected payment instrument details (e.g., payment data {Credit Card FOP}) is sent by the client device 110 and received by the reservation server 120 (e.g., a booking engine). For example, for FIG. 6D, the user at the client device 110 may have selected a form of payment combining payment for the travel event with frequent flyer miles and a credit card (e.g., via a reward slider on the user interface to select a percentage of frequent flyer miles to use). In response, the reservation server 120 generates and sends a form of payment request with the selected FOP information (e.g., payment information, such as frequent flyer miles and credit card number information) to the form of payment orchestration server 660. At block 612, the form of payment orchestration server 660 via the form of payment orchestration instruction set 670 determines, via the FOP orchestrator module 671 and based on the form of payment data associated with a travel request/booking, whether or not additional modules are needed for different options. Because a combination of payment options with frequent flyer miles is selected, an additional module is necessary for the example illustrated in FIG. 6D. Thus, at block 640, the FOP orchestrator module 671 at the FOP orchestration server 660 determines to utilize and send a reward data integration request to the reward integration module 174. The reward integration module 674 then executes the reward data integration request and returns updated payment data to the FOP orchestration server 660 with instructions on the combination of payment options with frequent flyer miles.

At block 642, in response to the combination of payment and instructions received with the updated payment data from the reward integration module 674, the form of payment process proceeds with the FOP orchestration server 660 generating and sending an authorization request to the APS server 150. The APS server 150 receives the authorization request and the form of payment data and provides an authorization response the FOP orchestration server 660 on approval to proceed. If approved, the FOP orchestration server 660 then provides a payment concealment storage request to the secure storage module 677 that in turn stores the payment data and provides payment concealment response data that may include associated encryption data for the particular payment transaction. After receiving the payment concealment response data from the secure storage module 677, the FOP orchestration server 660, at block 614, generates an FP element associated with the form of payment and transaction data, securely stores the payment data in the PNR. The FOP orchestration server 660 then provides form of payment authorization data to the travel provider server 130 and/or reservation server 120 regarding the execution of payment based on the user selected form of payment. The reservation server 120 may then provide the payment results for display at a payment page at the client device 110.

FIG. 6E illustrates the sequence diagram 600E, which is initiated at the client device 110 via application 112 when the user selects a form of payment method (e.g., a credit card, online bank account, frequent flyer miles, etc.) at a user interface. The selected payment instrument details (e.g., payment data {Credit Card FOP}) is sent by the client device 110 and received by the reservation server 120 (e.g., a booking engine). For example, for FIG. 6E, the user at the client device 110 may have selected a form of payment that includes an installment plan. In response, the reservation server 120 generates and sends a form of payment request with the selected FOP information (e.g., payment information, such as frequent flyer miles and credit card number information) to the form of payment orchestration server 660. At block 612, the form of payment orchestration server 660 via the form of payment orchestration instruction set 670 determines, via the FOP orchestrator module 671 and based on the form of payment data associated with a travel request/booking, whether or not additional modules are needed for different options. Because an installment plan is selected, an additional module is necessary for the example illustrated in FIG. 6E. Thus, at block 650, the FOP orchestrator module 671 at the FOP orchestration server 660 determines to utilize and send installment plan request to the installment module 675. The installment module 675 then executes the installment plan request and returns updated installment and payment data to the FOP orchestration server 660 with instructions on the installment plan options and the partial payment information (if applicable).

At block 652, in response to the installment plan, payment options, and instructions received with the updated payment data from the installment module 675, the form of payment process proceeds with the FOP orchestration server 660 generating and sending an authorization request to the APS server 150. The APS server 150 receives the authorization request and the form of payment data and provides an authorization response the FOP orchestration server 660 on approval to proceed. If approved, the FOP orchestration server 660 then provides a payment concealment storage request to the secure storage module 677 that in turn stores the payment data and provides payment concealment response data that may include associated encryption data for the particular payment transaction. After receiving the payment concealment response data from the secure storage module 677, the FOP orchestration server 660, at block 614, generates an FP element associated with the form of payment and transaction data, securely stores the payment data in the PNR. The FOP orchestration server 660 then provides form of payment authorization data to the travel provider server 130 and/or reservation server 120 regarding the execution of payment based on the user selected form of payment. The reservation server 120 may then provide the payment results for display at a payment page at the client device 110.

FIG. 6F illustrates the sequence diagram 600F, which is initiated at the client device 110 via application 112 when the user selects a form of payment method (e.g., a credit card, online bank account, frequent flyer miles, etc.) at a user interface. The selected payment instrument details (e.g., payment data {Credit Card FOP}) is sent by the client device 110 and received by the reservation server 120 (e.g., a booking engine). For example, for FIG. 6F, the user at the client device 110 may have selected an alternate currency for payment. In response, the reservation server 120 generates and sends a form of payment request with the selected FOP information (e.g., payment information, such as frequent flyer miles and credit card number information) to the form of payment orchestration server 660. At block 612, the form of payment orchestration server 660 via the form of payment orchestration instruction set 670 determines, via the FOP orchestrator module 671 and based on the form of payment data associated with a travel request/booking, whether or not additional modules are needed for different options. Because an alternative currency is selected, an additional module is necessary for the example illustrated in FIG. 6F. Thus, at block 680, the FOP orchestrator module 671 at the FOP orchestration server 660 determines to utilize and send an alternate currency request to the alternative currency module 676. The alternative currency module 676 then executes the alternate currency request and returns updated currency and payment data to the FOP orchestration server 660 with instructions on the alternative currency options and the payment information.

At block 682, in response to the alternative currency plan, payment options, and instructions received with the updated payment data from the alternative currency module 676, the form of payment process proceeds with the FOP orchestration server 660 generating and sending an authorization request to the APS server 150. The APS server 150 receives the authorization request and the form of payment data and provides an authorization response the FOP orchestration server 660 on approval to proceed. If approved, the FOP orchestration server 660 then provides a payment concealment storage request to the secure storage module 677 that in turn stores the payment data and provides payment concealment response data that may include associated encryption data for the particular payment transaction. After receiving the payment concealment response data from the secure storage module 677, the FOP orchestration server 660, at block 614, generates an FP element associated with the form of payment and transaction data, securely stores the payment data in the PNR. The FOP orchestration server 660 then provides form of payment authorization data to the travel provider server 130 and/or reservation server 120 regarding the execution of payment based on the user selected form of payment. The reservation server 120 may then provide the payment results for display at a payment page at the client device 110.

The actions of the form of payment orchestration server(s) 160 utilizing the form of payment orchestration instruction set 670 to process a form of payment protocol are further described herein with reference to a method flowchart for process 700 in FIG. 7.

FIG. 7 illustrates a flowchart of an example process 700 for implementing and providing a form of payment authorization process, according to embodiments of the invention. Operations of the process 700 can be implemented, for example, by a system that includes one or more data processing apparatus, such as one or more form of payment orchestration server(s) 660 utilizing a form of payment orchestration instruction set 670. The process 700 can also be implemented by instructions stored on computer storage medium, where execution of the instructions by a system that includes a data processing apparatus cause the data processing apparatus to perform the operations of the process 700.

The system, at a device that includes one or more processors, receives a form of payment request via a payment orchestration user interface at a client device (710). The device may include, e.g., the FOP orchestration server 660 utilizing the FOP orchestration module 671 of the FOP orchestration instruction set 670. In some implementations, the payment request is encoded with payment identification information. In some implementations, the FOP orchestration service provides access to one or more payment processor servers (e.g., APS server(s) 150), a plurality of FOP service modules (e.g., the submodules 671-677 of the form of payment orchestration instruction set 670), and a payment security database (e.g., payment database(s) 152).

In some implementations, the FOP request is received at a front-end API (e.g., a “payment page”) at a client device (e.g., from a travel provider server via a booking engine). For example, as illustrated in each of the sequence diagrams of FIGS. 6A-6F, the client device 110 may initiate a payment (e.g., a form of payment request) to the reservation server 120 (e.g., a user selects and executes the payment method). In some implementations, the FOP request is associated with a travel booking request. In some implementations, the FOP request is received from a travel provider server (e.g., travel provider server(s) 130) via a booking engine. A payment identification may be associated with a travel record identification pertaining to the FOP request. In some implementations, the reservation system (e.g., reservation server(s) 120) processed the travel record identification.

The system obtains user data associated with a transaction corresponding to the FOP request (720). For example, as illustrated in each of the sequence diagrams of FIGS. 6A-6F, the reservation server 120, initiates a form of payment orchestration protocol by communicating a form of payment request to one of the form of payment orchestration servers 660. In some implementations, the user data associated with the transaction corresponding to the FOP request includes PNR content and/or payment rules. For example, the user data may include an internal configuration of the particular merchant associated with the reservation server 120, such as payment rules, i.e., vouchers before loyalty points/miles.

The system determines payment transaction data based on the payment identification information and the user data (730). For example, the form of payment orchestration server 660 receives the form of payment request from the reservation server 120, and the form of payment orchestration server 660 may be able to decode the request. For example, determine the specific user data (e.g., PNR data) associated with the client and the merchant for the particular engagement and FOP request.

The system determines payment authorization data by managing access to one or more of the plurality of FOP service modules based on the payment transaction data (740). For example, the form of payment orchestration server 660 via the form of payment orchestration instruction set 670 may determine which of the micro-services (e.g., the submodules 671-677 of the form of payment orchestration instruction set 670) to access for the particular request. In some implementations, the payment authorization data may include FOP orchestration data, payment instruments, traveler related data (e.g., specific card numbers, online banking accounts, etc.), and/or payment options (e.g., installments, alternative currency, etc.), rewards, and the like.

In some implementations, managing access to the one or more of the plurality of FOP service modules based on the payment transaction data may include determining which of the micro-services to access for the particular request (e.g., accessing each of the submodules 671-677 of the form of payment orchestration instruction set 670). In some implementations, providing the payment authorization request to the payment platform server based on the payment authorization data includes encoding the payment authorization request based on the selected one or more of the plurality of FOP service modules that are required to execute the FOP request.

The system provides a payment authorization request to a payment platform server based on the payment authorization data (750). For example, as illustrated in one or more of the sequence diagrams of FIGS. 6A-6F, the form of payment orchestration servers 660 determines which of the plurality of payment service modules, aka, micro-services (e.g., submodules 671-677) to access to proceed with the form of payment orchestration protocol, and then requests an authorization protocol from the APS server 150. In some implementations, the form of payment data includes at least one or more of payment orchestration data, payment instruments, traveler related data (e.g., specific card numbers, online payment accounts, etc.) and/or payment options associated with the payment request (e.g., installments, currency conversion, and the like).

The system receives payment authorization data from the payment platform server (760) and stores the payment authorization data in a security payment database based on a FOP security protocol (770). For example, the payment authorization data and/or all of the payment details for the feeds and with respect to PCI-DSS security audit constraints are received (e.g., at the FOP orchestration server 660 from the APS server(s) 150) and are stored in a secure manner (e.g., after the payment and all needed operations have been processed). For example, the secure storage module 677 securely manages and stores all payment information in the one or more payment database(s) 152. In some implementations, storing the payment authorization data in the security payment database based on the FOP security protocol includes storing payment data in a user account (e.g., a PNR account) associated with the user data. For example, storing payment data in the PNR by adding new lines in an EDIFACT message, i.e., the PASBCQ, which is the EDIFACT representation of the PNR.

The system provides the payment authorization data via the FOP orchestration service at the merchant device (780). For example, the front-end EDIFACT/API (e.g., the merchant “FOP payment page”) at the merchant device (e.g., travel provider) receives and displays the FOP authorization and proceeds with execution of the payment.

In some implementations, prior to providing the authorization data, the process 700 may include performing a validation process to verify each of the accessed service modules of the plurality of service modules were correctly selected. For example, the process 700 may be able to check for errors during the form of payment orchestration process and go back to a same or a different payment service module based on a detected error (e.g., issues may be caused previously by users who go back/forth with vouchers, miles, cash, installments, etc.).

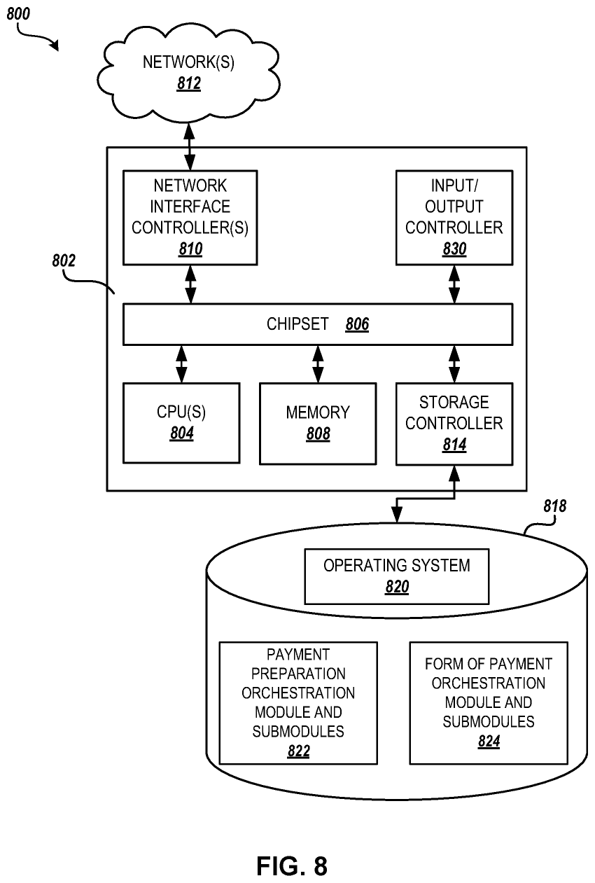

FIG. 8 illustrates an example computer architecture 800 for a computer 802 capable of executing the software components described herein for the sending/receiving and processing of tasks. The computer architecture 800 (also referred to herein as a “server”) shown in FIG. 8 illustrates a server computer, workstation, desktop computer, laptop, a server operating in a cloud environment, or other computing device, and may be utilized to execute any aspects of the software components presented herein described as executing on a host server, or other computing platform. The computer 802 preferably includes a baseboard, or “motherboard,” which is a printed circuit board to which a multitude of components or devices may be connected by way of a system bus or other electrical communication paths. In one illustrative embodiment, one or more central processing units (CPUs) 804 operate in conjunction with a chipset 806. The CPUs 804 can be programmable processors that perform arithmetic and logical operations necessary for the operation of the computer 802.

The CPUs 804 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The chipset 806 provides an interface between the CPUs 804 and the remainder of the components and devices on the baseboard. The chipset 806 may provide an interface to a memory 808. The memory 808 may include a random-access memory (RAM) used as the main memory in the computer 802. The memory 808 may further include a computer-readable storage medium such as a read-only memory (ROM) or non-volatile RAM (NVRAM) for storing basic routines that that help to startup the computer 802 and to transfer information between the various components and devices. The ROM or NVRAM may also store other software components necessary for the operation of the computer 802 in accordance with the embodiments described herein.

According to various embodiments, the computer 802 may operate in a networked environment using logical connections to remote computing devices through one or more networks 812, a local-area network (LAN), a wide-area network (WAN), the Internet, or any other networking topology known in the art that connects the computer 802 to the devices and other remote computers. The chipset 806 includes functionality for providing network connectivity through one or more network interface controllers (NICs) 810, such as a gigabit Ethernet adapter. For example, the NIC 810 may be capable of connecting the computer 802 to other computer devices in the utility provider's systems. It should be appreciated that any number of NICs 810 may be present in the computer 802, connecting the computer to other types of networks and remote computer systems beyond those described herein.

The computer 802 may be connected to at least one mass storage device 818 that provides non-volatile storage for the computer 802. The mass storage device 818 may store system programs, application programs, other program modules, and data, which are described in greater detail herein. The mass storage device 818 may be connected to the computer 802 through a storage controller 814 connected to the chipset 806. The mass storage device 818 may consist of one or more physical storage units. The storage controller 814 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 802 may store data on the mass storage device 818 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 818 is characterized as primary or secondary storage, or the like. For example, the computer 802 may store information to the mass storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 802 may further read information from the mass storage device 818 by detecting the physical states or characteristics of one or more particular locations within the physical storage units.

The mass storage device 818 may store an operating system 820 utilized to control the operation of the computer 802. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 818 may store other system or application programs and data utilized by the computer 802, such as the payment preparation orchestration module and submodules 822, which may include the payment preparation orchestration instruction set 170 and the one or more submodules included therein, according to embodiments described herein. For example, the payment preparation orchestration module and submodules 822 may include submodules such as the FOP catalogue module 171, the installment module 172, the currency conversion module 173, the payment wallet module 174, the FOP solution module 175, the balance inquiry module 176, the reward integration module 177, the user interface module 178, the authentication module 179, and/or other modules discussed herein or may otherwise be appropriate. Additionally, the mass storage device 818 may store other system or application programs and data utilized by the computer 802, such as the form of payment orchestration module and submodules 824, which may include the form of payment orchestration instruction set 670 and the one or more submodules included therein, according to embodiments described herein. For example, the form of payment orchestration module and submodules 824 may include submodules such as the FOP orchestrator module 671, the pricing module 672, the BIN verification module 673, the reward integration module 674, the installment module 675, the alternative currency module 676, the secure storage module 677, the authentication module 678, and/or other modules discussed herein or may otherwise be appropriate. Other system or application programs and data utilized by the computer 802 may be provided as well (e.g., a security module, a fraud module, a validation module, etc.).

In some embodiments, the mass storage device 818 may be encoded with computer-executable instructions that, when loaded into the computer 802, transforms the computer 802 from being a general-purpose computing system into a special-purpose computer capable of implementing the embodiments described herein. These computer-executable instructions transform the computer 802 by specifying how the CPUs 804 transition between states, as described above. According to some embodiments, from the payment preparation orchestration server(s) 160 perspective, the mass storage device 818 stores computer-executable instructions that, when executed by the computer 802, perform portions of the process 500, for implementing a payment preparation orchestration system, and perform portions of the process 700, for implementing a form of payment orchestration system, as described herein. In further embodiments, the computer 802 may have access to other computer-readable storage medium in addition to or as an alternative to the mass storage device 818.

The computer 802 may also include an input/output controller 830 for receiving and processing input from a number of input devices, such as a keyboard, a mouse, a touchpad, a touch screen, an electronic stylus, or other type of input device. Similarly, the input/output controller 830 may provide output to a display device, such as a computer monitor, a flat-panel display, a digital projector, a printer, a plotter, or other type of output device. It will be appreciated that the computer 802 may not include all of the components shown in FIG. 8, may include other components that are not explicitly shown in FIG. 8, or may utilize an architecture completely different than that shown in FIG. 8.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method comprising:
at a device comprising one or more processors:
receiving a payment request via a payment orchestration user interface at a client device, wherein the payment request is encoded with payment identification information, and the payment orchestration user interface provides access to a plurality of payment processor servers and a plurality of payment service modules;
obtaining configuration data associated with a merchant corresponding to the payment request;
determining payment transaction data based on the payment identification information and the configuration data associated with the merchant;
determining a subset of the plurality of payment service modules to engage based on the payment transaction data;
determining payment preparation data by managing access to each payment service module of the subset of the plurality of payment service modules; and
providing, via the payment orchestration user interface at the client device, a view of the payment preparation data.

2. The method of claim 1, wherein the configuration data associated with the merchant corresponding to the payment request comprises payment rules.

3. The method of claim 1, wherein the payment preparation data comprises at least one or more of payment orchestration data, payment instruments, traveler related data, and payment options.

4. The method of claim 1, wherein the plurality of payment service modules comprises at least one or more of:
a form of payment (FOP) catalogue module;
an installment module;
a currency conversion module;
a payment wallet module;
a FOP solution module;
a balance inquiry module;
a reward integration module;
a user interface module; and
an authentication module.

5. The method of claim 4, wherein the FOP solution module is configured to offer a dispatch of payment instruments for various products associated with the payment request based on products to buy, the payment instruments selected by a traveler, and applicability constraints.

6. The method of claim 1, wherein, prior to providing the view of the payment preparation data, performing a validation process to verify each of the accessed payment service modules of the plurality of payment service modules were correctly selected.

7. The method of claim 1, wherein the payment request is associated with a travel booking request.

8. The method of claim 7, wherein the payment request is received from a travel provider server via a booking engine.

9. The method of claim 1, further comprising:
receiving a form of payment (FOP) request via a FOP orchestration service from a merchant device, wherein the FOP request is encoded with the payment identification information, and wherein the FOP orchestration service provides access to the plurality of payment processor servers, a plurality of FOP service modules, and a payment security database;
obtaining user data associated with a transaction corresponding to the FOP request;
determining the payment transaction data based on the payment identification information and the user data;
determining payment authorization data by managing access to one or more of the plurality of FOP service modules based on the payment transaction data;
providing a payment authorization request to a payment platform server based on the payment authorization data;
receiving payment authorization data from the payment platform server;
storing the payment authorization data in a security payment database based on a FOP security protocol; and
providing, via the FOP orchestration service at the merchant device, the payment authorization data.

10. The method of claim 9, wherein the payment authorization data comprises at least one or more of payment orchestration data, payment instruments, traveler related data, and payment options.

11. The method of claim 9, wherein determining the payment authorization data by managing access to one or more of the plurality of FOP service modules based on the payment transaction data comprises selecting one or more of the plurality of FOP service modules that are required to execute the FOP request.

12. The method of claim 11, wherein providing the payment authorization request to the payment platform server based on the payment authorization data comprises encoding the payment authorization request based on the selected one or more of the plurality of FOP service modules that are required to execute the FOP request.

13. A device comprising:
a non-transitory computer-readable storage medium; and
one or more processors coupled to the non-transitory computer-readable storage medium, wherein the non-transitory computer-readable storage medium comprises program instructions that, when executed by the one or more processors, cause the one or more processors to:
receive a payment request via a payment orchestration user interface at a client device, wherein the payment request is encoded with payment identification information, and the payment orchestration user interface provides access to a plurality of payment processor servers and a plurality of payment service modules;
obtain configuration data associated with a merchant corresponding to the payment request;
determine payment transaction data based on the payment identification information and the configuration data associated with the merchant;
determine a subset of the plurality of payment service modules to engage based on the payment transaction data;
determine payment preparation data by managing access to each payment service module of the subset of the plurality of payment service modules; and
provide, via the payment orchestration user interface at the client device, a view of the payment preparation data.

14. The device of claim 13, wherein the configuration data associated with the merchant corresponding to the payment request comprises payment rules.

15. The device of claim 13, wherein the payment preparation data comprises at least one or more of payment orchestration data, payment instruments, traveler related data, and payment options.

16. The device of claim 13, wherein the plurality of payment service modules comprises at least one or more of:
a form of payment (FOP) catalogue module;
an installment module;
a currency conversion module;
a payment wallet module;
a FOP solution module;
a balance inquiry module;
a reward integration module;
a user interface module; and
an authentication module.

17. The device of claim 16, wherein the FOP solution module is configured to offer a dispatch of payment instruments for various products associated with the payment request based on products to buy, the payment instruments selected by a traveler, and applicability constraints.

18. The device of claim 13, wherein, prior to providing the view of the payment preparation data, performing a validation process to verify each of the accessed payment service modules of the plurality of payment service modules were correctly selected.

19. The device of claim 13, wherein the payment request is associated with a travel booking request.

20. The device of claim 19, wherein the payment request is received from a travel provider server via a booking engine.

21. The device of claim 13, wherein the non-transitory computer-readable storage medium comprises program instructions that, when executed by the one or more processors, further cause the one or more processors to:
receive a form of payment (FOP) request via a FOP orchestration service from a merchant device, wherein the FOP request is encoded with the payment identification information, and wherein the FOP orchestration service provides access to the plurality of payment processor servers, a plurality of FOP service modules, and a payment security database;
obtain user data associated with a transaction corresponding to the FOP request;
determine the payment transaction data based on the payment identification information and the user data;
determine payment authorization data by managing access to one or more of the plurality of FOP service modules based on the payment transaction data;
provide a payment authorization request to a payment platform server based on the payment authorization data;
receive payment authorization data from the payment platform server;
store the payment authorization data in a security payment database based on a FOP security protocol; and
provide, via the FOP orchestration service at the merchant device, the payment authorization data.

22. The device of claim 21, wherein the payment authorization data comprises at least one or more of payment orchestration data, payment instruments, traveler related data, and payment options.

23. The device of claim 21, wherein determining the payment authorization data by managing access to one or more of the plurality of FOP service modules based on the payment transaction data comprises selecting one or more of the plurality of FOP service modules that are required to execute the FOP request.

24. The device of claim 23, wherein providing the payment authorization request to the payment platform server based on the payment authorization data comprises encoding the payment authorization request based on the selected one or more of the plurality of FOP service modules that are required to execute the FOP request.

25. A non-transitory computer storage medium encoded with a computer program, the computer program comprising a plurality of program instructions that when executed by one or more processors cause the one or more processors to:
receive a payment request via a payment orchestration user interface at a client device, wherein the payment request is encoded with payment identification information, and the payment orchestration user interface provides access to a plurality of payment processor servers and a plurality of payment service modules;
obtain configuration data associated with a merchant corresponding to the payment request;
determine payment transaction data based on the payment identification information and the configuration data associated with the merchant;
determine a subset of the plurality of payment service modules to engage based on the payment transaction data;
determine payment preparation data by managing access to each payment service module of the subset of the plurality of payment service modules; and
provide, via the payment orchestration user interface at the client device, a view of the payment preparation data.
